(19) United States
(12) Patent Application Publication
(10) Pub. No.: US 2026/0180914 A1
(43) Pub. Date: Jun. 25, 2026

(54) METHODS AND APPARATUS FOR SELECTIVE OUT OF ORDER DELIVERY

(71) Applicant: Huawei Technologies Co., Ltd., Shenzhen (CN)

(72) Inventors: Yunsong Yang, San Diego, CA (US); Satish Chandra Jha, Portland, OR (US)

(21) Appl. No.: 19/545,655

(22) Filed: Feb. 20, 2026

Related U.S. Application Data
(63) Continuation of application No. PCT/US2024/043628, filed on Aug. 23, 2024.
(60) Provisional application No. 63/578,423, filed on Aug. 24, 2023.

(51) Int. Cl. H04L 47/34; H04L 69/22; H04W 80/02

(52) U.S. Cl. CPC H04L 47/34; H04L 69/22; H04W 80/02

(57) ABSTRACT

According to implementations, a communication device receives a packet data convergence protocol (PDCP) protocol data unit (PDU) over a data radio bearer (DRB) configured for the communication device. The PDCP PDU includes an indication of a delivery mode to be used in delivering PDCP SDUs received on the DRB to an upper layer associated with the communication device, where the indication of the delivery mode indicates in-order delivery (IOD) or out-of-order delivery (OOD). The communication device processes the PDCP PDU to produce a PDCP SDU and a COUNT value associated with the PDCP SDU. The communication device delivers the PDCP SDU to the upper layer in accordance with an indication of the delivery mode.

### CROSS-REFERENCE TO RELATED APPLICATIONS

This patent application is a continuation of International Application No. PCT/US2024/043628, filed on Aug. 23, 2024, and entitled “Methods and Apparatus for Selective Out of Order Delivery,” which claims priority to U.S. Provisional Application No. 63/578,423, filed on Aug. 24, 2023, and entitled “Methods and Apparatus for Selective Out of Order Delivery,” applications of which are hereby incorporated by reference herein as if reproduced in their entireties.

### TECHNICAL FIELD

The present disclosure relates generally to wireless communications, and, in particular embodiments, to methods and apparatus for delivering a data stream mixed with data requiring in-order delivery and data not requiring in-order delivery by selectively applying in-order delivery and out-of-order delivery.

### BACKGROUND

Packet Data Convergence Protocol (PDCP) is a protocol layer placed above the Radio Link Control (RLC) Layer and below either the Service Data Adaptation Protocol (SDAP) layer (for user plane) or the Radio Resource Control (RRC) layer (for control plane) in the radio protocol stack in 5th generation (5G) new radio (NR). The PDCP layer provides following services to an associated upper layer (e.g., the RRC layer or the SDAP layer):
Transfer of user plane data
Transfer of control plane data
Header compression
Ciphering and Integrity Protection.

### SUMMARY

Technical advantages are generally achieved, by embodiments of this disclosure which describe methods and apparatus.

According to implementations, a communication device receives a packet data convergence protocol (PDCP) protocol data unit (PDU) over a data radio bearer (DRB) configured for the communication device. The communication device is configured to select, on a per service data unit (SDU) basis, a delivery mode from in-order delivery (IOD) and out-of-order delivery (OOD) to be used in delivering PDCP SDUs received on the DRB to an upper layer associated with the communication device. The communication device processes the PDCP PDU to produce a PDCP SDU and a COUNT value associated with the PDCP SDU. The communication device delivers the PDCP SDU to the upper layer in accordance with an indication of the delivery mode.

In some implementations, a PDCP-config information element (IE) configured for the communication device may include first information indicating that performing the OOD selectively is configured for the DRB.

In some implementations, the communication device may deliver the PDCP SDU regardless of another PDCP SDU with a respective COUNT value less than a COUNT value associated with the PDCP SDU has been received.

In some implementations, the indication of the delivery mode may be included in a PDCP header of the PDCP PDU. The PDCP header may include a field for carrying the indication of the delivery mode, and the field may include one or more bits having a first value and a second value indicating the OOD and IOD, respectively. The one or more bits can be an OOD bit, an IOD bit or a combination of the OOD bit and the IOD bit.

In some implementations, the communication device may receive a first PDCP control PDU over the DRB. A PDU type field in the first PDCP control PDU may indicate the OOD. The COUNT value associated with the PDCP SDU may be indicated in the first PDCP control PDU as being associated with the OOD.

In some implementations, the COUNT value associated with the PDCP SDU being indicated in the first PDCP control PDU as being associated with the OOD may comprise the COUNT value associated with the PDCP SDU being indicated in a first OOD COUNT field in the first PDCP control PDU.

In some implementations, the COUNT value associated with the PDCP SDU being indicated in the first PDCP control PDU as being associated with the OOD may comprise a bit in a bitmap field in the first PDCP control PDU being set to a value indicating the OOD. A bit position of the bit in the bitmap field may correspond to the COUNT value associated with the PDCP SDU.

In some implementations, in response to that the indication indicating the delivery mode indicates the IOD, the communication device may deliver the PDCP SDU to the upper layer as if the OOD is not configured for the DRB.

In some implementations, the communication device may store the PDCP SDU in a buffer in response to determining that another PDCP SDU with a respective COUNT value less than the COUNT value associated with the PDCP SDU has not been received yet and is still waited for. The communication device may deliver the PDCP SDU to the upper layer in response to determining that all PDCP SDUs with the respective COUNT value less than the COUNT value associated with the PDCP SDU have either been delivered to the upper layer or been determined as being lost.

In some implementations, the communication device may receive a second PDCP control PDU over the DRB. A PDU type field in the second PDCP control PDU may indicate the IOD. The COUNT value associated with the PDCP SDU may be indicated in the second PDCP control PDU as being associated with the IOD.

In some implementations, the communication device may be a user equipment (UE) or a next generation Node B (gNB).

According to implementations, a communication device receives, from an upper layer associated with the communication device, a PDCP SDU for transmission over a DRB configured between the communication device and a second communication device. The communication device may be configured to support the second communication device to select, on a per SDU basis, a delivery mode from IOD and OOD to be used in delivering PDCP SDUS received on the DRB from the communication device to a second upper layer associated with the second communication device. The communication device processes the PDCP SDU to produce a PDCP PDU that includes an indication of a delivery mode, where the indication of the delivery mode indicates IOD or OOD such that delivering PDCP SDUs received on the DRB from the communication device to a second upper layer associated with the second communication device can be based on the indication of the delivery mode. The communication device transmits the PDCP PDU to the second communication device.

In some implementations, a PDCP-config information element (IE) configured for the communication device may include first information indicating that supporting the second communication device to select the delivery mode is configured for the communication device.

In some implementations, in response to determining that the PDCP SDU does not require the IOD, the communication device may convey a first indication indicating the OOD to the second communication device.

In some implementations, the first indication indicating the OOD may be included in a PDCP header of the PDCP PDU transmitted to the second communication device. For example, the PDCP header includes an OOD bit set to 1 to indicate the OOD.

In some implementations, the communication device may transmit a first PDCP control PDU over the DRB to the second communication device. A PDU type field in the first PDCP control PDU may indicate the OOD. A COUNT value associated with the PDCP SDU may be indicated in the first PDCP control PDU as being associated with the OOD.

In some implementations, the COUNT value associated with the PDCP SDU being indicated in the first PDCP control PDU as being associated with the OOD may comprise the COUNT value associated with the PDCP SDU being indicated in a first OOD COUNT field in the first PDCP control PDU.

In some implementations, the COUNT value associated with the PDCP SDU being indicated in the first PDCP control PDU as being associated with the OOD may include a bit in a bitmap field in the first PDCP control PDU being set to a value indicating the OOD. A bit position of the bit in the bitmap field may correspond to the COUNT value associated with the PDCP SDU.

In some implementations, the communication device may receive a second indication indicating that the PDCP SDU does not require the IOD. In some implementations, the communication device may receive the PDCP SDU from the associated upper layer for the transmission over a first quality of service (QoS) flow. Data of the first QoS flow may not require the IOD.

In some implementations, in response to determining that the PDCP SDU requires the IOD, the communication device may convey a third indication indicating the IOD to the second communication device.

In some implementations, the third indication indicating the IOD may be included in a PDCP header of the PDCP PDU transmitted to the second communication device. In some implementations, the third indication may include an IOD bit set to a value (e.g., 1) in the PDCP header of the PDCP PDU transmitted to the second communication device.

In some implementations, the communication device may transmit a second PDCP control PDU over the DRB to the second communication device. A PDU type field in the second PDCP control PDU may indicate the IOD. A COUNT value associated with the PDCP SDU may be indicated in the second PDCP control PDU as being associated with the IOD.

In some implementations, the communication device may receive a fourth indication indicating that the PDCP SDU requires the IOD. In some implementations, the communication device may receive the PDCP SDU from the associated upper layer for the transmission over a second QoS flow. Data of the second QoS flow may require the IOD.

In some implementations, the communication device may be a UE or a gNB.

### BRIEF DESCRIPTION OF THE DRAWINGS

For a more complete understanding of the present disclosure, and the advantages thereof, reference is now made to the following descriptions taken in conjunction with the accompanying drawings, in which:

FIG. 1 illustrates an example PDCP data PDU format with 12-bit PDCP SN, according to some implementations;

FIG. 2 illustrates an example PDCP data PDU format with 18-bit PDCP SN, according to some implementations;

FIG. 3 illustrates an example PDCP control PDU format, according to some implementations;

FIG. 4 illustrates another example PDCP control PDU format, according to some implementations;

FIG. 5 illustrates a flow diagram of example operations occurring in a PDCP entity that transmits data, according to some implementations;

FIG. 6 illustrates a flow diagram of example operations occurring in a PDCP entity that receives data, according to some implementations;

FIG. 7 illustrates an example sequence of events and signaling exchanges occurring among a UE and various network nodes, according to some implementations;

FIG. 8 illustrates another example sequence of events and signaling exchanges occurring among a UE and various network nodes, according to some implementations;

FIG. 9 illustrates yet another example sequence of events and signaling exchanges occurring among a UE and various network nodes, according to some implementations;

FIG. 10A illustrates a flow chart of a method performed by a communication device, according to some implementations;

FIG. 10B illustrates a flow chart of a method performed by a communication device, according to some implementations;

FIG. 11 illustrates an example communications system, according to implementations;

FIG. 12 illustrates an example communications system, according to some implementations;

FIGS. 13A and 13B illustrate example devices that may implement the methods and teachings according to this disclosure; and

FIG. 14 is a block diagram of a computing system that may be used for implementing the devices and methods disclosed herein.

Corresponding numerals and symbols in the different figures generally refer to corresponding parts unless otherwise indicated. The figures are drawn to clearly illustrate the relevant aspects of the embodiments and are not necessarily drawn to scale.

### DETAILED DESCRIPTION OF ILLUSTRATIVE EMBODIMENTS

The making and using of embodiments of this disclosure are discussed in detail below. It should be appreciated, however, that the concepts disclosed herein can be embodied in a wide variety of specific contexts, and that the specific embodiments discussed herein are merely illustrative and do not serve to limit the scope of the claims. Further, it should be understood that various changes, substitutions and alterations can be made herein without departing from the spirit and scope of this disclosure as defined by the appended claims.

To transmit user plane data over a data radio bearer (DRB), a transmitting PDCP entity is configured on a transmitting device to process PDCP service data units (SDUs) arrived from an associated upper layer entity (such as an SDAP entity for the user plane), where the transmitting device may be a radio access network (RAN) node, such as a next generation Node B (gNB), for downlink (DL) transmissions or a user equipment (UE) for uplink (UL) or sidelink transmissions. More specifically, the transmitting PDCP entity assigns a unique COUNT value, which is an integer number and is incremented by 1 after each assignment, to each of the PDCP SDUs as they respectively arrive from the upper layer, performs header compression, integrity protection, and encryption on the PDCP SDUs, adds respective PDCP headers to produce the corresponding PDCP data protocol data units (PDUs), each respective PDCP header including a PDCP sequence number (SN), which is a specific number (e.g., 12 or 18) of least significant bits (LSBs) of the COUNT value associated with the respective PDCP SDU, and submits the PDCP data PDUs to associated RLC entity(s) for transmission in the order of the COUNT values assigned to the PDCP SDUs. However, in a wireless communication system, packets transmitted by the transmitting device may be successfully received by a receiving device out of order, i.e., received in a different order than the order that their respective transmissions began at the transmitting side, e.g., due to different numbers of lower-layer retransmissions (such as automatic repeat request (ARQ) retransmissions or hybrid ARQ (HARQ) retransmissions) used in successfully transmitting the packets and/or due to different transmission paths (for example, when dual connectivity is configured between the transmitting device and the receiving device) that the successfully received packets have gone through, respectively. In the description provided herein and hereafter, packets and data are generally interchangeable and PDCP PDUs generally refer to PDCP data PDUs except that various example PDCP control PDUs, such as the selective out-of-order delivery (OOD) control PDU and the selective in-order delivery (IOD) control PDU, will include the word “control” in the respective terms to differentiate them from the PDCP data PDUs.

To receive the user plane data transmitted over the DRB and as a peer entity of the transmitting PDCP entity, a receiving PDCP entity is configured on the receiving device to process received PDCP PDUs to produce the corresponding PDCP SDUs and to deliver the PDCP SDUs to an associated upper layer, where the receiving device may be a UE for DL transmissions, a RAN node such as a gNB for UL transmissions, or a peer UE for sidelink transmissions. The receiving PDCP entity uses the PDCP SN included in the PDCP header of the received PDCP PDU to reconstruct the COUNT value associated with the corresponding PDCP SDU and uses the COUNT value to determine whether the PDCP SDU is received out-of-order or not. For example, a PDCP SDU is received out-of-order if there is another PDCP SDU associated with a COUNT value less than the COUNT value associated with the PDCP SDU that has not been received yet and is still waited for; otherwise, the PDCP SDU is received in-order (or in-sequence). When determining that a PDCP SDU is received out-of-order and IOD is required, the receiving PDCP entity stores the PDCP SDU in a reordering buffer and postpones the delivery of the PDCP SDU to the upper layer until all missing PDCP SDU(s) associated with a COUNT value less than the COUNT value associated with the postponed PDCP SDU are either received and delivered to the upper layer or the waiting for them is finally abandoned, e.g., as a result of the expiry of a reordering timer. On the other hand, when determining that a PDCP SDU is received out-of-order and IOD is not required or when determining that the PDCP SDU is received in-order, the receiving PDCP entity delivers the PDCP SDU to the upper layer as soon as the PDCP SDU is produced from the corresponding PDCP PDU received. In accordance with the current PDCP specification developed by the third generation partnership project (3GPP), the receiving PDCP entity may be explicitly configured to use OOD for delivering the received PDCP SDUs if the data stream served by the receiving PDCP entity does not require IOD, which is also referred to as in-sequence delivery. When configured with OOD, the receiving PDCP entity delivers any received PDCP SDU to the associated upper layer entity as soon as it is successfully received, disregarding the order in which it was transmitted among other PDCP SDUs.

On the other hand, if the data stream served by the receiving PDCP entity requires IOD, the receiving PDCP entity is not to be configured to use OOD for delivering the received PDCP SDUs, and therefore by default, the receiving PDCP entity is configured to use IOD for delivering the received PDCP SDUs. When configured with IOD, the receiving PDCP entity delivers the received PDCP SDUs to the associated upper layer in the same order as they were transmitted by the transmitting PDCP entity. To ensure in-order delivery, the receiving PDCP entity uses the IOD in delivering received PDU SDUs. More specifically, the receiving PDCP entity reorders the received PDCP SDUs in accordance with the COUNT values which are respectively derived from the PDCP SNs in the PDCP headers of the associated PDCP PDUs; delivers a PDCP SDU if all PDCP SDUs associated with a COUNT value less than the COUNT value associated with the PDCP SDU to be delivered have either been delivered to the upper layer or been determined as being lost (and no longer waited for); otherwise, stores the PDCP SDU in a reordering buffer until either all prior missing PDCP SDUs are received and delivered or a reordering timer expires; upon the expiry of the reordering timer, determines PDCP SDUs associated with a COUNT value less than the value of state variable RX_REORD and having not been received yet as being lost and delivers PDCP SDUs stored in the reordering buffer sequentially in accordance with the associated COUNT values until the next PDCP SDU that has not been received yet but is still waited for.

In accordance with the current 5G NR PDCP specification (3GPP Technical Specification (TS) 38.323 v17.5.0, which is incorporated by reference in this disclosure), a receiving PDCP entity may be configured to either use only OOD or not to use OOD at all (i.e., to use IOD only) but not both, meaning that the receiving PDCP entity must apply either OOD or IOD, whichever one is configured, uniformly to all PDCP SDUs received over the DRB for delivering the PDCP SDUs to the associated upper layer. However, the current approach may be sub-optimal in the following usage scenarios.

For example, a first quality of service (QoS) flow requiring IOD and a second QoS flow not requiring IOD may be mapped onto a same DRB that the receiving PDCP entity is configured for. If the receiving PDCP entity is configured to use only OOD, data of the first QoS flow may be delivered to the upper layer out of order, potentially affecting operations at the upper layer and/or various protocol layers above it, e.g., triggering a request for retransmission at a higher layer (such as a TCP retransmission) unnecessarily. On the other hand, if the receiving PDCP entity is configured to use only IOD, delivery of received data of the second QoS flow to the upper layer in order may be unnecessarily delayed by a missing data that was transmitted on the DRB prior to the received data of the second QoS flow.

For another example, a DRB may be configured between a first device and a second device for a QoS flow carrying transmission control protocol (TCP) traffic. At the TCP layer, data of the QoS flow sent from the first device to the second device consists of TCP acknowledgements (ACKs) and first TCP data packets, the TCP ACKs being sent to acknowledge second TCP data packets received at the first device from the second device. Hence, a delivery order of the TCP ACKs is irrelevant to a delivery order of the first TCP data packets. If the receiving PDCP entity configured on the second device for the DRB is configured to use only OOD and PDCP SDUs that carry the first TCP data packets and are received out of order will be delivered to the associated upper layer (the SDAP layer) and higher layers (such as TCP layer) above it out of order, possibly triggering a higher layer retransmission (e.g., a TCP retransmissions) unnecessarily. If the receiving PDCP entity configured on the second device for the DRB is configured to use only IOD, delivery of received TCP ACKs may be unnecessarily delayed, resulting in a longer estimated round-trip time (RTT), which may cause a sender of the second TCP packets to reduce data rate due to a TCP congestion control mechanism.

A first objective is to enable a receiving PDCP entity to determine whether each packet received on a DRB, for which the receiving PDCP entity is configured, requires IOD or not on a per packet basis, and based thereon, to optimize the delivery of the each packet received to the upper layer accordingly, e.g., packets received on the DRB and determined as requiring IOD are delivered to the upper layer using IOD while packets received on the DRB and determined as not requiring IOD are delivered to the upper layer as soon as they are respectively received. The optimized delivery results in that data requiring IOD are still delivered to the upper layer using IOD, ensuring proper operations at the upper layer and layers above, and meanwhile, data not requiring IOD are delivered to the upper layer without unnecessary buffering and delaying at the receiving PDCP entity, and hence avoiding unnecessary retransmissions at a higher layer (such as TCP layer) and/or unnecessary data rate reduction due to a congestion control mechanism at the higher layer.

A second objective is to further enable the receiving PDCP entity to optimize the delivery of one or more packets received on the DRB, the one or more packets requiring IOD and being transmitted after a first packet, the first packet being not received yet and still waited for.

In various example embodiments, methods are provided for a user equipment (UE) or a first network node serving the UE determining that data of one or more QoS flows that are mapped to a DRB of the UE include both data requiring IOD and data not requiring IOD, causing the UE and/or one or more network nodes to perform various tasks for supporting a receiver on the DRB to deliver received data packets in different manners in accordance with the respective delivery requirements of individual data packets. For example, data received at the PDCP layer and requiring IOD are delivered to the upper layer of the receiver using IOD and data receiving at the PDCP layer but not requiring IOD are delivered to the upper layer as soon as they are respectively received. For another example, when the IOD is a default delivery mechanism to be used on the DRB, data requiring IOD are delivered as if OOD is not configured on the DRB while data not requiring IOD are delivered as if OOD is configured (and overriding the default IOD) on the DRB. Such mixed-mode delivery mechanism may be referred to as selective OOD, selective IOD, or selective IOD and OOD.

The disclosed methods further include means for the UE (for data transmitted on the uplink (UL) or sidelink) or a second network node serving the UE (for data transmitted on the downlink (DL)) determining whether each packet of the DRB of the UE or of the QoS flow(s) mapped to the DRB requires IOD or not on a per packet basis, and based thereon, conveying, to a transmitter on the DRB, the each packet along with an associated indication of IOD or OOD, as respectively determined for the each packet, the transmitter being the UE (for the data transmitted on the UL or the sidelink) or a gNB serving the UE (for the data transmitted on the DL).

The disclosed methods further include means for the transmitter to convey the each packet along with the associated indication of IOD or OOD to the receiver on the DRB, the receiver being the RAN node such as the gNB (for the data transmitted on the UL), or the UE (for the data transmitted on the DL), or a second UE (for the data transmitted on the sidelink, i.e., device-to-device transmission), the second UE being a peer UE of the UE. In some embodiments, the indication of IOD or OOD is conveyed explicitly for each packet. In some other embodiments, one of the two delivery mechanisms are pre-configured as the default mechanism and hence is not explicitly indicated (but is implicitly indicated when there is a lack of explicit indication of the other delivery mechanism) for associated packets, while the indication of the other delivery mechanism is explicitly conveyed to override the default mechanism for associated packets.

The disclosed methods further include means for the receiver determining whether each received packet of the DRB of the UE requires IOD or not, and based thereon, selecting IOD or OOD accordingly for delivering the each received packet to the upper layer, e.g., packets determined as requiring IOD are delivered using IOD, as described before, while packets determined as not requiring IOD are delivered as soon as they are respectively received.

The disclosed methods further include means for the receiver to optimize the delivery of one or more packets received on the DRB, the one or more packets requiring IOD and being transmitted after a first packet, the first packet being not received yet and still waited for, but the indication of IOD or OOD associated with the first packet being received by the receiver.

In a first embodiment, an session management function (SMF) (as the first network node in the first embodiment) serving the UE receives information of a QoS flow of the UE from a policy control function (PCF), the information indicating that the QoS flow includes both data requiring IOD and data not requiring IOD, and based thereon, the SMF configures (e.g., by providing information about type(s) of higher layer packet or value(s) in certain field(s) in one or more higher layer protocol headers) to a user plane function (UPF) (as the second network node in the first embodiment) serving the QoS flow to determine if IOD is required for each DL packet of the QoS flow, e.g., by the UPF performing deep-packet inspection (DPI) on the each DL packet, and based thereon, send indication of IOD or OOD accordingly along with the each DL packet to the gNB (as the DL transmitter). The SMF may also indicate to the gNB (e.g., via QoS profile of the QoS flow) that data of the QoS flow includes both data requiring IOD and data not requiring IOD, causing the gNB to configure 1) a transmitting PDCP entity of the gNB to include an indication of IOD or OOD in PDCP header of PDCP PDU carrying the each DL packet in accordance with the respective indication of IOD or OOD received from the UPF for the each DL packet; and 2) the UE (as the DL receiver) to perform selective OOD accordingly. The SMF may also configure the UE (as the UL transmitter) to determine if IOD is required for each UL packet of the QoS flow, and based thereon, send to the gNB (as the UL receiver) an indication of IOD or OOD in PDCP header of PDCP PDU carrying the each UL packet. Then, based on the received indication of IOD or OOD, a receiving PDCP entity configured on the gNB for the DRB performs selective OOD for delivering packet received on the UL to the associated upper layer.

In a second embodiment, the gNB (as both the first network node and the second network node in the second embodiment) receives information about first and second QoS flows of the UE from the SMF, the information indicating that the first QoS flow requires IOD and the second QoS flow does not, and the gNB decides to map both the first and the second QoS flows to a DRB configured for the UE. Hence, the gNB determines that data of the DRB include both data requiring IOD and data not requiring IOD, and based thereon, a SDAP entity or a transmitting PDCP entity configured on the gNB (as the DL transmitter) for the DRB determines, on a per packer basis, whether IOD is required for a DL packet arrives at the DRB based on whether the DL packet belongs to the first or the second QoS flow, as identified by a QoS flow ID (QFI) associated with the DL packet, the QFI being conveyed in the general packet radio service (GPRS) tunneling protocol-user plane (GTP-U) header of the GTP-U packet carrying the DL packet from the UPF to the gNB. If the QFI indicates the first QoS flow, an explicit or implicit indication of IOD may be included in the PDCP header of the PDCP PDU carrying the DL packet. If the QFI indicates the second QoS flow, an explicit or implicit indication of OOD may be included in the PDCP header of the PDCP PDU carrying the DL packet. The gNB may also configure the UE (as the UL transmitter) to similarly include indication of IOD or OOD, as determined by the UE's higher layer, in the PDCP header of the PDCP PDU carrying the UL packet. The gNB may also configure a receiving PDCP entity of the UE (as the DL receiver) and a receiving PDCP entity of the gNB (as the UL receiver) to perform selective OOD in accordance with the indication of IOD or OOD in the PDCP header of PDCP PDUs received on the DL and the UL, respectively.

In a third embodiment, higher layer(s) (e.g., Application and/or TCP layers) of the UE determines that data of a DRB of the UE include data requiring IOD and data not requiring IOD. The UE may inform the SMF of the determination to cause the SMF to configure the UPF (as the second network node in the third embodiment) to perform DPI on each DL packet to determine whether IOD is required for the each DL packet, and based thereon, send indication of IOD or OOD accordingly along with the each DL packet to the gNB (as the DL transmitter). The SMF may further indicate to the gNB, e.g., via QoS profile of QoS flow(s) that data of one or more QoS flows of the UE include both data requiring IOD and data not requiring IOD, causing the gNB to configure the use of selective OOD on the DRB. Alternatively, the UE may inform the gNB of the determination to cause the gNB to configure the use of selective OOD on the DRB. In either case, the gNB may configure the transmitting PDCP entity configured on the gNB (as the DL transmitter) for the DRB to include indication of IOD or OOD in PDCP header of PDCP PDU carrying a DL packet. The gNB may also configure the UE (as the UL transmitter) to similarly include indication of IOD or OOD, as determined by the UE's higher layer, in PDCP header of PDCP PDU carrying a UL packet. The gNB may also configure a receiving PDCP entity of the UE (as the DL receiver) and a receiving PDCP entity of the gNB (as the UL receiver) to perform selective OOD in accordance with the indication of IOD or OOD in PDCP header of PDCP PDUs received on the DL and on the UL, respectively.

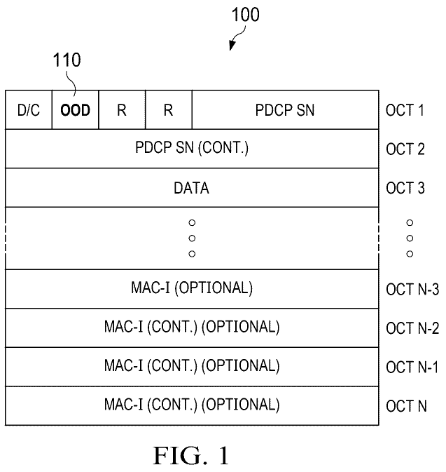

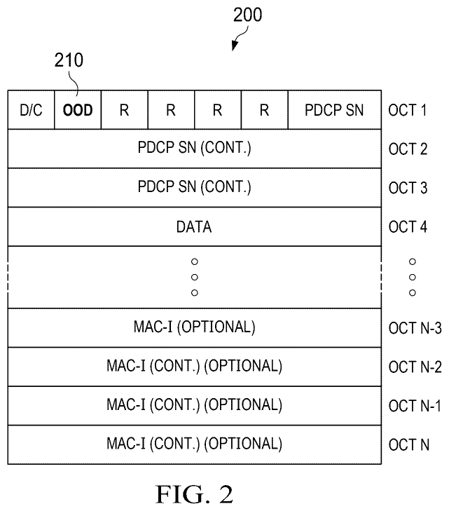

In one embodiment, the transmitter transmits each packet along with an associated indication of IOD or OOD to the receiver, the transmitter being the UE (for data transmitted on the UL or the sidelink) or the gNB (for data transmitted on the DL), and the receiver being the gNB (for the data transmitted on the UL) or the UE (for data transmitted on the DL) or a second UE (for data transmitted on the sidelink, i.e., device-to-device communication), the second UE being a peer UE of the UE. For example, the indication of IOD or OOD is conveyed using 1 bit (such as OOD bit in the field 110 in PDCP PDU format 100 or OOD bit in the field 210 in PDCP PDU format 200, illustrated in FIG. 1 and FIG. 2, respectively) in the PDCP header of the PDCP PDU carrying the each packet, e.g., with value ‘1’ indicating OOD to be used and value ‘o’ indicating IOD to be used. For example, when OOD is not configured in the PDCP-config information element (IE) configured for the DRB using the RRC signaling (hence IOD being the default delivery mechanism for the DRB), if a packet does not require IOD, the transmitting PDCP entity sets an OOD bit (such as OOD bit in the field 110 or the field 210) to ‘1’ in the PDCP header of the PDCP PDU carrying the packet to the receiver; otherwise, the transmitting PDCP entity sets the OOD bit to ‘0’. A reversal of the assignment of the ‘0’ and ‘1’ values is possible. Bit(s) in the field 110 or the field 210 may also be referred to as the IOD bit(s), IOD/OOD bits, or OOD/IOD bits. For example, the bit(s) in the field 110 or the field 210 is referred to as IOD bit(s), when OOD is configured in the PDCP-config IE configured for the DRB (hence OOD being the default delivery mechanism), if a packet requires IOD, the transmitting PDCP entity sets an IOD bit (such as IOD bit in the field 110 or the field 210) to ‘1’ in the PDCP header of the PDCP PDU carrying the packet to the receiver; otherwise, the transmitting PDCP entity sets the IOD bit to ‘0’.

The following text further describes some example detailed behaviors of the receiving PDCP entity. In particular, some example behaviors in various embodiments of conveying indication of IOD or OOD in the PDCP header of the PDCP PDU sent from the transmitting PDCP entity to the receiving PDCP entity, are described herein:

Actions when a PDCP Data PDU is Received from Lower Layer

In this embodiment, following definitions are used:
HFN(State Variable): the HFN part (i.e. the number of most significant bits equal to HFN length) of the State Variable;
SN(State Variable): the SN part (i.e. the number of least significant bits equal to PDCP SN length) of the State Variable;
RCVD_SN: the PDCP SN of the received PDCP Data PDU, included in the PDU header;
RCVD_HFN: the HFN of the received PDCP Data PDU, calculated by the receiving PDCP entity;
RCVD_COUNT: the COUNT of the received PDCP Data PDU=[RCVD_HFN, RCVD_SN].
   At reception of a PDCP Data PDU from lower layers, the receiving PDCP entity shall determine the COUNT value of the received PDCP Data PDU, i.e. RCVD_COUNT, as follows:
if RCVD_SN<SN(RX_DELIV)−Window_Size:
   RCVD_HFN=HFN(RX_DELIV)+1.
else if RCVD_SN>=SN(RX_DELIV)+Window_Size:
   RCVD_HFN=HFN(RX_DELIV)−1.
else:
   RCVD_HFN=HFN(RX_DELIV);
RCVD_COUNT=[RCVD_HFN, RCVD_SN].

After determining the COUNT value of the received PDCP Data PDU=RCVD_COUNT, the receiving PDCP entity shall:
perform deciphering and integrity verification of the PDCP Data PDU using COUNT=RCVD_COUNT;
   if integrity verification fails:
      indicate the integrity verification failure to upper layer;
      discard the PDCP Data PDU and consider it as not received;
if RCVD_COUNT<RX_DELIV; or
if the PDCP Data PDU with COUNT=RCVD_COUNT has been received before:
   discard the PDCP Data PDU; If the received PDCP Data PDU with COUNT value=RCVD_COUNT is not discarded above, the receiving PDCP entity shall:
store the resulting PDCP SDU in the reception buffer;
if RCVD_COUNT>=RX_NEXT:
   update RX_NEXT to RCVD_COUNT+1.
if outOfOrderDelivery is configured; or
if selectiveOutOfOrderDelivery is configured and the Out-of-Order Delivery (OOD) bit in the PDCP header of the PDCP Data PDU is set:
   deliver the resulting PDCP SDU to upper layers after performing header decompression using EHC.
if RCVD_COUNT=RX_DELIV:
   deliver to upper layers in ascending order of the associated COUNT value after performing header decompression, if not decompressed before;
      all stored PDCP SDU(s) with consecutively associated COUNT value(s) starting from COUNT=RX_DELIV, skipping (i.e., neither delivering nor stopping the delivery by) any PDCP SDUs that have already been delivered to upper layers out of order; —update RX_DELIV to the COUNT value of the first PDCP SDU which has not been delivered to upper layers, with COUNT value>RX_DELIV;
   if t-Reordering is running, and if RX_DELIV>=RX_REORD:
      stop and reset t-Reordering.
   if t-Reordering is not running (includes the case when t-Reordering is stopped due to actions above), and RX_DELIV<RX_NEXT:
      update RX_REORD to RX_NEXT;
      start t-Reordering.
         Actions when a t-Reordering Expires

When t-Reordering expires, the receiving PDCP entity shall:
deliver to upper layers in ascending order of the associated COUNT value after performing header decompression, if not decompressed before:
all stored PDCP SDU(s) with associated COUNT value(s)<RX_REORD, except any PDCP SDUs that have already been delivered to upper layers out of order;
all stored PDCP SDU(s) with consecutively associated COUNT value(s) starting from RX_REORD, skipping (i.e., neither delivering nor stopping the delivery by) any PDCP SDUs that have already been delivered to upper layers out of order.

Alternative embodiments for the transmitter conveying the indication of IOD or OOD to the receiver over the air may be implemented.

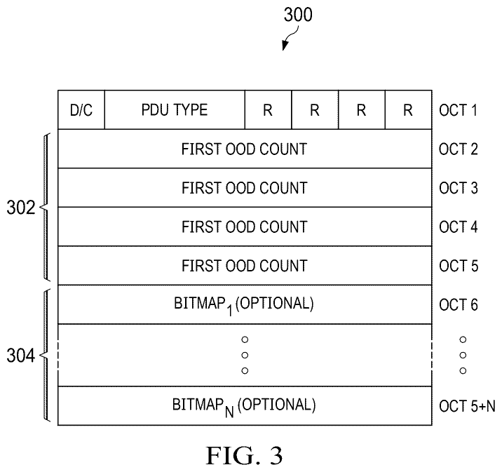

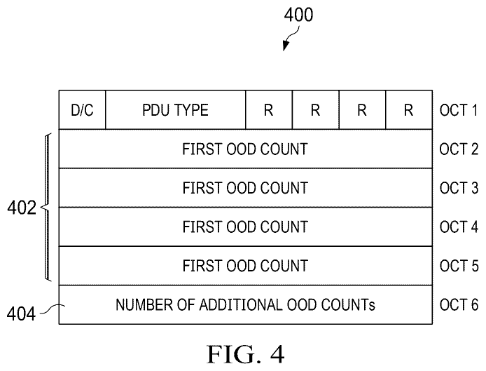

In some cases, majority of PDCP SDUs of the DRB require IOD while a small number of the PDCP SDUs do not. In some implementations, instead of indicating IOD or OOD in every PDCP data PDU, IOD may be configured and used as the default delivery mechanism, e.g., by not configuring OOD in the PDCP-config IE configured for the DRB, and, if a PDCP SDU of the DRB indeed does not require IOD, the transmitting PDCP entity sends a PDCP control PDU, which may be referred to as the (PDCP) Selective OOD control PDU, to the receiving PDCP entity to indicate that OOD can be used in delivering one or more PDCP SDUs as indicated, e.g., the Selective OOD control PDU including a Data/Control (D/C) field set to value 0 (zero) to indicate that the PDU is a PDCP control PDU, a PDU Type field carrying a specific value indicating that the control PDU is the Selective OOD control PDU, and a First OOD COUNT field (e.g., the field 302 in the PDCP control PDU format 300 or the field 402 in the PDCP control PDU format 400) indicating COUNT value associated with a first PDCP SDU that does not require IOD. If multiple PDCP SDUs do not require IOD, the Selective OOD control PDU may further include a bitmap field 304, as shown in FIG. 3, indicating whether COUNT values following the First OOD COUNT value are associated with a PDCP SDU requiring IOD or not, e.g., bits with value 1 in the bitmap indicating the corresponding COUNT values being associated with a PDCP SDU not requiring IOD and bits with value 0 indicating the corresponding COUNTs being associated with a PDCP SDU requiring IOD. A reversal of the assignment of the 0 and 1 values may be possible. In an alternative format for the Selective OOD control PDU, instead of using the bitmap, the Selective OOD control PDU may optionally include a Number of Additional OOD COUNTs field 404 to indicate the number of consecutive COUNT values that follow the first OOD COUNT value and are associated with a PDCP SDU not requiring IOD, as shown in FIG. 4. PDCP SDUs not indicated as not requiring IOD by a Selective OOD control PDU are delivered using IOD by default. The fields 302, 304, 402 and 404 are included in PDCP SDUs of PDCP control PDUs.

Similarly, when the majority of PDCP SDUs of the DRB don't require IOD while only a small number of the PDCP SDUs of the DRB require IOD, it is also possible to make the use of OOD as the default delivery mechanism for the DRB (e.g., by configuring OOD in the PDCP-config IE for the DRB), and if a PDCP SDU of the DRB for a particular direction (e.g., DL, UL, or sidelink) indeed requires IOD, the transmitting PDCP entity configured for the DRB for that direction sends another PDCP control PDU, referred to as the Selective IOD control PDU, to the receiving PDCP entity configured for the DRB for that direction to indicate that IOD shall be used in delivering one or more PDCP SDUs as indicated by the (PDCP) Selective IOD control PDU. For example, the Selective IOD control PDU includes a First IOD COUNT field indicating the COUNT value of a first PDCP SDU that requires IOD. If there are more than one PDCP SDUs that require IOD, the Selective IOD control PDU may further include a Bitmap field or a Number of Additional IOD COUNTs field to indicate COUNT values that follow the First IOD COUNT value and are associated with a PDCP SDU requiring IOD, using similar PDCP control PDU format as illustrated in FIGS. 3 and 4, except that the PDU Type field carries a specific value identifying the control PDU as the Selective IOD control PDU and that fields relating to OOD can be changed to relating to IOD.

When the indication of IOD or OOD associated with a PDCP SDU is conveyed within a PDCP PDU that carries the PDCP SDU and the PDCP PDU is missing at the receiving PDCP entity, the receiving entity does not know whether the missing PDCP SDU requires IOD or not. In this situation, if the receiving PDCP entity receives subsequent PDCP SDUs, which require IOD, the delivery of these received subsequent PDCP SDUs will be delayed until the receiving PDCP entity receives the missing PDCP PDU or the reordering timer expires. Such delaying may be unnecessary when the missing PDCP SDU does not require IOD, which the receiving PDCP entity does not know, unless the indication of IOD or OOD associated with the missing PDCP PDU is conveyed in another way.

Hence, an advantage of the transmitting PDCP entity sending a Selective OOD control PDU to indicate PDCP SDU(s) not requiring IOD, as described, is that if the receiving PDCP entity receives the Selective OOD control PDU, all PDCP SDUs not received yet and still waited for are among the PDCP SDUs being indicated as not requiring IOD in the Selective OOD control PDU (or in any prior Selective OOD control PDUs received), and the receiving PDCP entity receives one or more subsequent PDCP SDUs requiring IOD, the receiving PDCP entity may immediately deliver the one or more subsequent PDCP SDUs to the upper layer.

Another advantage of the transmitting PDCP entity sending the Selective OOD control PDU to indicate PDCP SDU(s) not requiring IOD is that the receiving PDCP entity may further choose not to start any reordering timer if all PDCP SDUs not received yet and still waited for are indicated by the Selective OOD control PDU as not requiring IOD.

Similarly, when OOD is configured as the default delivery mechanism on the DRB for a particular direction and a Selective IOD control PDU would be sent by the transmitting PDCP entity to the receiving PDCP entity to indicate PDCP SDU(s) requiring IOD, if the receiving PDCP entity receives the Selective IOD control PDU but all PDCP SDUs not received yet and still waited for are not indicated as requiring IOD in the Selective IOD control PDU (or in any prior Selective IOD control PDU received), or if the receiving PDCP entity receives no Selective IOD control PDU yet, then the receiving PDCP entity does not start any reordering timer due to any PDCP SDU not received yet and still waited for.

Similar to the example behaviors of the embodiments of conveying indication of IOD or OOD in a PDCP control PDU, alternative embodiments are described herein:

Actions when a PDCP Data PDU is Received from Lower Layer

At reception of a PDCP Data PDU from lower layers, the receiving PDCP entity shall determine the COUNT value of the received PDCP Data PDU, i.e. RCVD_COUNT, as follows:
if RCVD_SN<SN(RX_DELIV)−Window_Size:
   RCVD_HFN=HFN(RX_DELIV)+1.
else if RCVD_SN>=SN(RX_DELIV)+Window_Size:
   RCVD_HFN=HFN(RX_DELIV)−1.
else:
   RCVD_HFN=HFN(RX_DELIV);
RCVD_COUNT=[RCVD_HFN, RCVD_SN].

After determining the COUNT value of the received PDCP Data PDU=RCVD_COUNT, the receiving PDCP entity shall:
perform deciphering and integrity verification of the PDCP Data PDU using COUNT=RCVD_COUNT;
   if integrity verification fails:
      indicate the integrity verification failure to upper layer;
      discard the PDCP Data PDU and consider it as not received;
if RCVD_COUNT<RX_DELIV; or
if the PDCP Data PDU with COUNT=RCVD_COUNT has been received before:
   discard the PDCP Data PDU; If the received PDCP Data PDU with COUNT value=RCVD_COUNT is not discarded above, the receiving PDCP entity shall:
store the resulting PDCP SDU in the reception buffer;
if RCVD_COUNT>=RX_NEXT:
   update RX_NEXT to RCVD_COUNT+1.
if outOfOrderDelivery is configured; or
if selectiveOutOfOrderDelivery is configured and RCVD_COUNT has been indicated as Out-of-Order Delivery (OOD) by a Selective OOD control PDU received or all COUNT values prior to RCVD_COUNT, of which a PDCP SDU has not been delivered yet and still waited for, have been indicated as Out-of-Order Delivery (OOD) by a Selective OOD control PDU received:
   deliver the resulting PDCP SDU to upper layers after performing header decompression using EHC.
if RCVD_COUNT=RX_DELIV:
   deliver to upper layers in ascending order of the associated COUNT value after performing header decompression, if not decompressed before;
      all stored PDCP SDU(s) with consecutively associated COUNT value(s) starting from COUNT=RX_DELIV, skipping (i.e., neither delivering nor stopping the delivery by) any PDCP SDUs that have already been delivered to upper layers out of order.

Additional embodiments for the NG-U, NGAP, and NAS signaling may be implemented.

In some embodiments previously described, for data transmitting on the DL, the UPF (as an embodiment of the second network node) determines whether IOD is required on a DL packet or not. After the determination, the UPF conveys an indication of IOD or OOD, as determined for the DL packet, via the GTP-U extension header of the GTP-U packet that carries the DL packet over the NG-U interface from the UPF to the gNB serving the UE.

If all DL packets of a QoS flow of the UE do not require IOD, the SMF may indicate such characteristics to the gNB in the QoS profile of the QoS flow via next generation application protocol (NGAP) signaling (e.g., PDU Session management or UE Context management related) messages, and based thereon, the SDAP entity of the gNB conveys an indication of OOD to the transmitting PDCP entity configured on the gNB (as the DL transmitter) for the DRB for all DL packets arrived from the QoS flow at the SDAP entity of the gNB. If all DL packets of the QoS flow require IOD, the SMF may indicate such characteristics to the gNB in the QoS profile of the QoS flow, and based thereon, the SDAP entity of the gNB conveys an indication of IOD to the transmitting PDCP entity configured on the gNB for the DRB for all DL packets arrived from the QoS flow at the SDAP entity of the gNB.

If all UL packets of a QoS flow do not require IOD, the SMF may indicate such characteristics in the QoS rules sent to the UE via a non-access stratum (NAS) signaling (e.g., PDU Session management or UE Context management related) messages, and based thereon, the SDAP entity of the UE conveys an indication of OOD to the transmitting PDCP entity configured on the UE (as the UL transmitter) for the DRB for all UL packets arrived from the QoS flow at the SDAP entity of the UE. If all UL packets of the QoS flow require IOD, the SMF may indicate such characteristics to the UE in the QoS rules sent to the UE via the NAS signaling, and based thereon, the SDAP entity of the UE conveys an indication of IOD to the transmitting PDCP entity configured on the UE for the DRB for all UL packets arrived from the QoS flow at the SDAP entity of the UE.

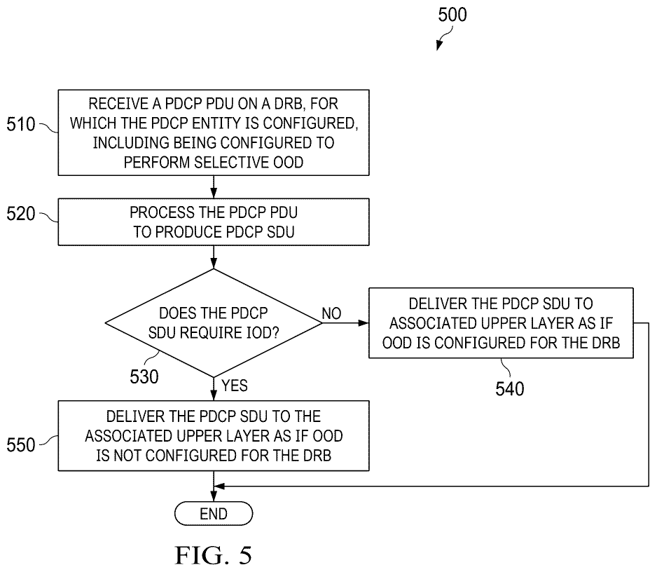

FIG. 5 illustrates a flow diagram of example operations 500 occurring in a PDCP entity, according to some implementations. Operations 500 may be indicative of operations occurring in a PDCP entity, as the PDCP entity receives data and performs selective OOD in delivering received data to an upper layer entity. The upper layer entity may be, for example, an SDAP entity. The PDCP entity may be configured in a UE when the data are transmitted to the UE or in a gNB when the data are transmitted to the gNB.

Operations 500 begin with the PDCP entity receiving a PDCP PDU on a DRB, for which the PDCP entity is configured, including being configured to perform selective OOD in delivering received data to an upper layer entity, at the operation 510. The PDCP entity processes the PDCP PDU to produce a PDCP SDU carried by the PDCP PDU at the operation 520. Processing the PDCP PDU may include performing reconstruction of associated COUNT value from PDCP SN included in PDCP header, removing the PDCP header, deciphering, integrity verification, duplicate detection and removal, and header decompression, etc. The PDCP entity determines whether the PDCP SDU requires in-order delivery (IOD) or not at the operation 530. For example, the PDCP entity may determine whether an Out-of-Order Delivery (OOD) bit in the PDCP header of the PDCP PDU is set to value 1 or value 0. If value 1, the PDCP SDU does not require IOD. If value 0, the PDCP SDU requires IOD. A reversal of the assignment of the 0 and 1 values may be possible. For another example, the PDCP entity may determine whether an In-Order Delivery (IOD) bit in the PDCP header of the PDCP PDU is set to value 1 or value 0. If value 1, the PDCP SDU requires IOD. If value 0, the PDCP SDU does not require IOD. A reversal of the assignment of the 0 and 1 values is possible. For yet another example, IOD is the default delivery mechanism on the DRB, and the PDCP entity determines whether it has received a (PDCP) Selective OOD control PDU, as described above, the PDCP SDU being among the PDCP SDUs, which are indicated as not requiring IOD in the Selective OOD control PDU. If such Selective OOD control PDU has been received, the PDCP SDU does not require IOD; otherwise, the PDCP SDU requires IOD. For yet another example, OOD is the default delivery mechanism on the DRB, and the PDCP entity determines whether it has received a (PDCP) Selective IOD control PDU, as described above, the PDCP SDU being among the PDCP SDUS, which are indicated as requiring IOD in the Selective OOD control PDU. If such Selective IOD control PDU has been received, the PDCP SDU requires IOD; otherwise, the PDCP SDU does not require IOD.

If the PDCP entity determines that the PDCP SDU does not require IOD at the operation 530, the PDCP entity delivers the PDCP SDU to the associated upper layer entity as if OOD is configured on the DRB, i.e., delivering the PDCP SDU to the associated upper layer entity as soon as possible, at the operation 540. If the PDCP entity determines that the PDCP SDU requires IOD at the operation 530, the PDCP entity delivers the PDCP SDU to the associated upper layer entity as if OOD is not configured on the DRB, i.e., delivering the PDCP SDU to the associated upper layer entity using IOD, at the operation 550. Then, operations 500 may end.

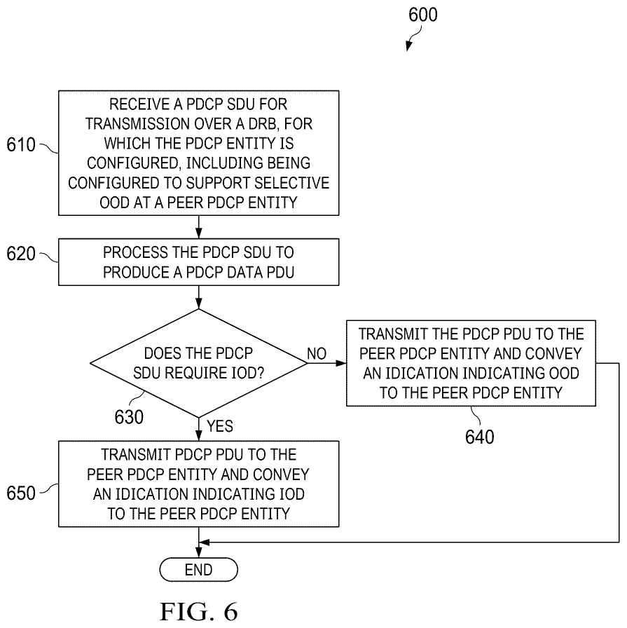

FIG. 6 illustrates a flow diagram of example operations 600 occurring in a PDCP entity, according to some implementations. Operations 600 may be indicative of operations occurring in a PDCP entity, as the PDCP entity transmits data to a peer PDCP entity in a manner that enables the peer PDCP entity to perform selective OOD in delivering received data received from the PDCP entity to an upper layer entity associated with the peer PDCP entity. The upper layer entity may be, for example, an SDAP entity. The PDCP entity may be configured in a UE when the data are transmitted by the UE or a gNB when the data are transmitted by the gNB.

Operations 600 begin with the PDCP entity receiving, from a second upper layer entity associated with the PDCP entity, a PDCP SDU for transmission over a DRB, for which the PDCP entity is configured, including being configured to support selective OOD at the peer PDCP entity, at the operation 610. The PDCP entity processes the PDCP SDU to produce a PDCP PDU carrying the PDCP SDU at the operation 620. Processing the PDCP SDU may include performing assignment of a unique COUNT value, header compression, integrity protection, ciphering, and adding PDCP header, etc. The PDCP entity determines whether the PDCP SDU requires in-order delivery (IOD) or not at the operation 630. For example, the PDCP entity may have received, from the upper layer entity (e.g., the SDAP entity) associated with the PDCP entity, the PDCP SDU along with an indication of IOD or OOD associated with the PDCP SDU. For example, for data transmitted on the DL, the indication of IOD or OOD may have been determined by the UPF based on DPI and conveyed to the GTP-U entity of the gNB, then to the PDCP entity configured at the gNB (as the transmitter on the DL). For data transmitted on the UL, the indication of IOD or OOD may have been determined by a higher layer entity of the UE and then conveyed to the PDCP entity configured at the UE (as the transmitter on the UL). Alternatively, the indication of IOD or OOD may have been determined by the associated SDAP entity based on information about a first QoS flow and a second QoS flow mapped onto the DRB and a QFI associated with a SDAP SDU that carries the PDCP SDU, the information indicating the first QoS flow requires IOD and the second QoS flow does not, and the QFI identifying whether the SDAP SDU comes from the first QOS flow or the second QoS flow, and then conveyed to the PDCP entity.

If the PDCP entity determines that the PDCP SDU does not require IOD at the operation 630, the PDCP entity transmits the PDCP PDU to the peer PDCP entity and conveys an indication indicating OOD to the peer PDCP entity at the operation 640. For example, the indication indicating OOD may be conveyed to the peer PDCP entity by setting an OOD bit in the PDCP header of the PDCP PDU to value 1. For another example, the indication indicating OOD may be conveyed to the peer PDCP entity by setting an IOD bit in the PDCP header of the PDCP PDU to value 0. For yet another example, the indication indicating OOD may be implicitly conveyed to the peer PDCP entity by configuring OOD to be the default delivery mechanism and by not setting an IOD bit in the PDCP header of the PDCP PDU to value 1. For yet another example, the indication indicating OOD may be conveyed to the peer PDCP entity by the PDCP entity sending a (PDCP) Selective OOD control PDU to the peer PDCP entity, the Selective OOD control PDU indicating the PDCP SDU not requiring IOD (or the PDCP SDU being among the PDCP SDUs that are indicated as not requiring IOD by the Selective OOD control PDU). For yet another example, the indication indicating OOD may be implicitly conveyed to the peer PDCP entity by configuring OOD to be the default delivery mechanism and by the PDCP entity not sending a (PDCP) Selective IOD control PDU that indicates the PDCP SDU requiring IOD (or being among the PDCP SDUs that are indicated as requiring IOD by the Selective IOD control PDU).

If the PDCP entity determines that the PDCP SDU requires IOD at the operation 630, the PDCP entity transmits the PDCP PDU to the peer PDCP entity and conveys an indication indicating IOD to the peer PDCP entity at the operation 650. For example, the indication indicating IOD may be conveyed to the peer PDCP entity by setting an OOD bit in the PDCP header of the PDCP PDU to value 0. For another example, the indication indicating IOD may be conveyed to the peer PDCP entity by setting an IOD bit in the PDCP header of the PDCP PDU to value 1. For yet another example, the indication indicating IOD may be implicitly conveyed to the peer PDCP entity by configuring IOD to be the default delivery mechanism and by not setting an OOD bit in the PDCP header of the PDCP PDU to value 1. For yet another example, the indication indicating IOD may be conveyed to the peer PDCP entity by the PDCP entity sending a (PDCP) Selective IOD control PDU to the peer PDCP entity, the Selective IOD control PDU indicating the PDCP SDU requiring IOD (or the PDCP SDU being among the PDCP SDUs that are indicated as requiring IOD by the Selective IOD control PDU). For yet another example, the indication indicating IOD may be implicitly conveyed to the peer PDCP entity by configuring IOD to be the default delivery mechanism and by the PDCP entity not sending a (PDCP) Selective OOD control PDU that indicates the PDCP SDU not requiring IOD (or the PDCP SDU being among the PDCP SDUs that are indicated as not requiring IOD by the Selective OOD control PDU). Then, operations 600 may end.

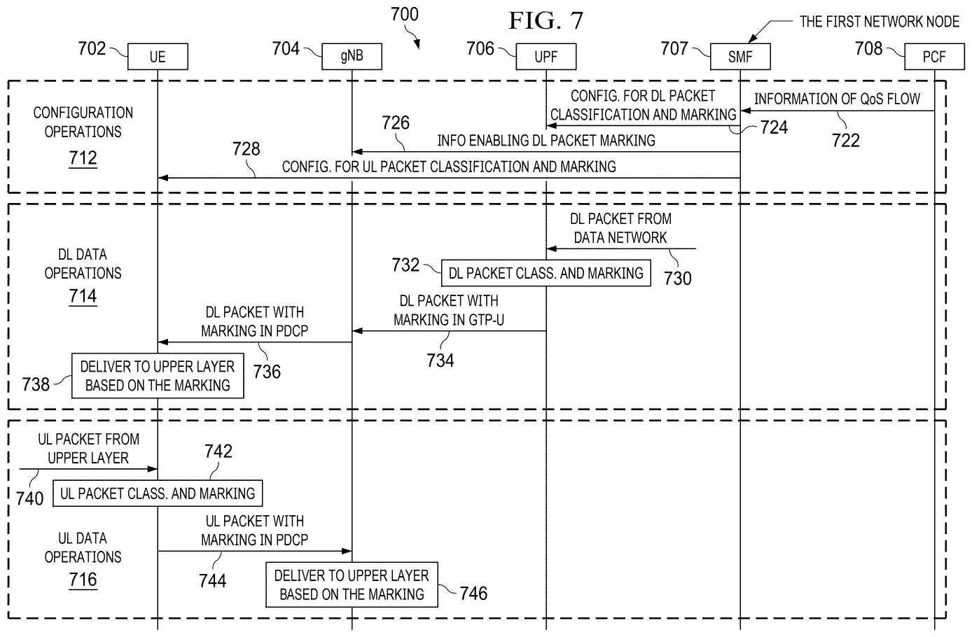

FIG. 7 illustrates a network flow 700, involving a UE 702, a gNB 704, a UPF 706, an SMF 707, and a PCF 708, according to some implementations. The operations of the network flow 700 may include three operation phases: configuration operations 712, DL data operations 714, and UL data operations 716.

The configuration operations 712 may include operations 722, 724, 726, and 728. At the operation 722, the SMF 707 (as the first network node) serving the UE 702 receives information of a QoS flow of the UE 702 from the PCF 708. The information indicates that the QoS flow includes both data requiring IOD and data not requiring IOD. Based thereon, at the operation 724, the SMF 707 configures (e.g., by providing information about type(s) of higher layer packet or value(s) in certain field(s) in one or more higher layer protocol headers to) the UPF 706 serving the QoS flow to determine if IOD is required for each DL packet of the QoS flow (related to the operation 732), e.g., by the UPF performing DPI on the each DL packet in accordance with the information provided, and based thereon, to send an indication of IOD or OOD (i.e., marking in GTP-U) accordingly along with the each DL packet to the gNB 704 (as the DL transmitter) (related to the operation 734).

At the operation 726, the SMF 707 may also indicate to the gNB 704 (e.g., via QoS profile of the QoS flow) that data of the QoS flow include both data requiring IOD and data not requiring IOD, causing the gNB 704 to configure 1) a transmitting PDCP entity configured for the DRB on the gNB 704 to send an indication of IOD or OOD (i.e., marking in PDCP) for PDCP PDU carrying the each DL packet (related to the operation 736), the indication of IOD or OOD in PDCP being consistent with the indication of IOD or OOD in GTP-U received from the UPF 706; 2) the UE 702 (as the DL receiver) to perform selective OOD accordingly for the DL (related to the operations 738); and 3) a receiving PDCP entity configured for the DRB on the gNB 704 to perform selective OOD accordingly for the UL (related to the operations 746).

At the operation 728, the SMF 707 may also configure the UE 702 (as the UL transmitter) to determine if IOD is required for each UL packet of the QoS flow (related to the operations 742), and based thereon, to send to the gNB (as the UL receiver) an indication of IOD or OOD in PDCP (related to the operation 744), based on which indication, the receiving PDCP entity configured on the gNB 704 for the DRB performs selective OOD on UL.

The DL data operations 714 may include operations 730, 732, 734, 736, and 738. At the operation 730, a DL packet arrives at the UPF 706 from a data network (e.g., the Internet) that is external to the 5G core network. At the operation 732, the UPF 706 performs DL packet classification (i.e., determination of whether IOD is required for the DL packet or not) and marking (i.e., inserting an indication of IOD or OOD accordingly) on the DL packet. This classification and marking are based on the configuration received from the SMF 707 during the configuration operations 712, more specifically, during the operation 724. For example, the UPF 706 may perform DPI on the DL packet in accordance with the information provided with during the operation 724, such as the information about type(s) of higher layer packet or value(s) in certain field(s) in one or more higher layer protocol headers, etc.

At the operation 734, the UPF 706 sends the DL packet with the associated marking in a GTP-U packet to the gNB 704. At the operation 736, the gNB 704 retrieves the DL packet and the marking from the GTP-U packet, then sends the DL packet in a PDCP PDU, along with an indication indicating IOD or OOD (i.e., marking in PDCP) that is consistent with the marking in GTP-U received from the UPF 706, to the UE 702. The marking in PDCP may be sent by using an OOD bit or an IOD bit in the PDCP header of the PDCP PDU, or by additionally sending a (PDCP) Selective OOD control PDU or (PDCP) Selective IOD control PDU, as previously described.

At the operation 738, the UE 702 processes the PDCP PDU received to retrieve the DL packet, determines whether IOD is required for delivering the DL packet to the upper layer based on the IOD or OOD indication indicated in the PDCP header of the PDCP PDU, or in the (PDCP) Selective OOD control PDU, or in the (PDCP) Selective IOD control PDU, and delivers the packet to the upper layer in accordance with the corresponding delivery mechanism determined, as previously described.

The UL data operations 716 may include operations 740, 742, 744, and 746. At the operation 740, a UL packet from the upper layer arrives at the UE 702. At operation 742, the UE 702 performs UL packet classification (i.e., determination of whether IOD is required for the UL packet or not) and marking (i.e., inserting an indication of IOD or OOD accordingly) on the UL packet, following the configuration set by the SMF 707 during the configuration operations 712, more specifically, during the operation 728.

At the operation 744, the UE 702 sends the UL packet in a second PDCP PDU, along with the associated marking in PDCP, to the gNB 704. The marking in PDCP may be sent by using an OOD bit or an IOD bit in the PDCP header of the second PDCP PDU or by additionally sending a (PDCP) Selective OOD control PDU or (PDCP) Selective IOD control PDU, as previously described.

At operation 746, the gNB 704 processes the second PDCP PDU received to retrieve the UL packet, determines whether IOD is required for delivering the UL packet to the upper layer based on the IOD or OOD indication indicated in the PDCP header of the second PDCP PDU, or in the (PDCP) Selective OOD control PDU, or in the (PDCP) Selective IOD control PDU, and delivers the packet to its upper layer in accordance with the corresponding delivery mechanism determined, as previously described.

The operations 714 and 716 demonstrate how the network elements handle both downlink and uplink data packets based on the configurations established during the configuration operations 712. The disclosed techniques ensure proper classification, marking, and delivery of packets with consideration for In-Order Delivery (IOD) and Out-of-Order Delivery (OOD) requirements, on a per-packet basis, as configured earlier.

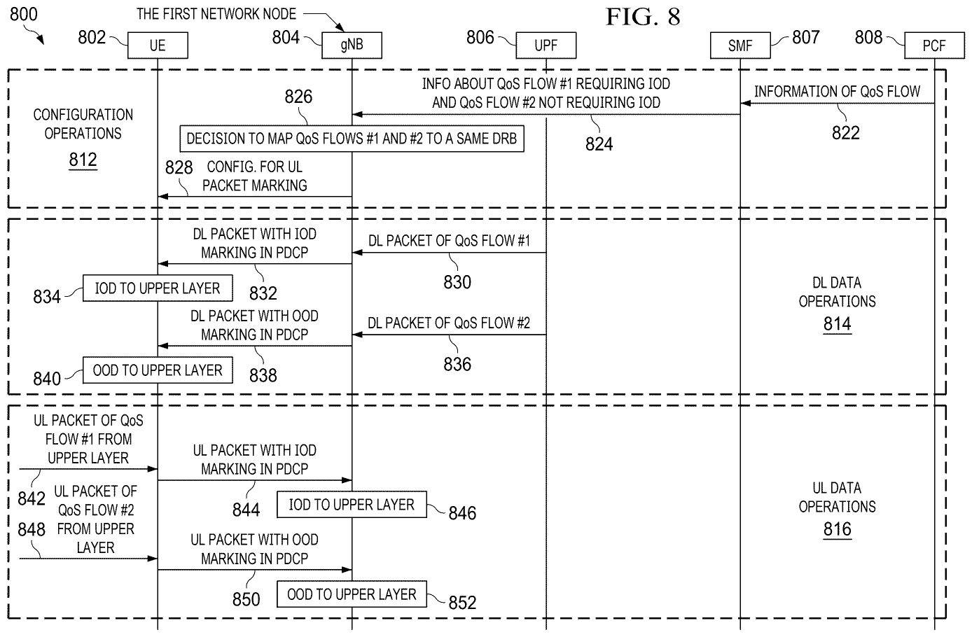

FIG. 8 illustrates a network flow 800, involving a UE 802, a gNB 804, a UPF 806, an SMF 807, and a PCF 808, according to some implementations. The operations of the network flow 800 may include three operation phases: configuration operations 812, DL data operations 814, and UL data operations 816.

The configuration operations 812 may include operations 822, 824, 826, and 828. At the operation 822, the PCF 808 sends information of QoS flows of the UE 802 to the SMF 807. At operation 824, the gNB 804 (as the first network node) receives information about first and second QoS flows of the UE 802 from the SMF 807, the information indicating that data of the first QoS flow require IOD and data of the second QoS flow do not.

At operation 826, the gNB 804 decides to map both the first and the second QoS flows to a same DRB configured for the UE 802. Hence, the gNB 804 determines that data of the DRB include both data requiring IOD and data not requiring IOD, and based thereon, configures the SDAP entity (which, in this case, further forwards its determination to the transmitting PDCP entity) or the transmitting PDCP entity of the gNB 804 (as the DL transmitter) for the DRB to determine whether IOD is required for each DL packet arrives at the DRB for transmission based on whether the each DL packet belongs to the first or the second QoS flow, as identified by a QFI associated with the each DL packet, the QFI being conveyed in the GTP-U header of the GTP-U packet carrying the DL packet from the UPF 806 to the gNB 804, and configures the transmitting PDCP entity of the gNB 804 to send indication of IOD or OOD to the UE 802 accordingly (related to the operations 832 and 838). If the QFI indicates the first QoS flow, IOD is required for the DL packet. If the QFI indicates the second QoS flow, IOD is not required for the DL packet. The gNB 804 may also configure the UE 802 (as the UL transmitter) to similarly determine, e.g., by the UE 802 inspecting specific field(s) in specific higher layer protocol header(s) in accordance with the configuration, whether IOD is required for each UL packet on the DRB, and based thereon, to provide indication of IOD or OOD to the gNB accordingly (related to the operations 844 and 850). The gNB 804 may also configure receiving PDCP entity of the UE 802 (as the DL receiver) (related to the operations 834 and 840) and receiving PDCP entity of the gNB 804 (as the UL receiver) (related to the operations 846 and 852) to perform selective OOD in accordance with the respective indication of IOD or OOD received.

The DL data operations 814 include operations 830, 832, 834, 836, 838, and 840. At the operation 830, a DL packet of QoS flow #1 arrives at the gNB 804. At the operation 832, the gNB 804 sends the DL packet with IOD marking in PDCP to the UE 802. For examples, the IOD marking in PDCP may be indicated by setting the IOD bit to value 1 or setting the OOD bit to value 0 in the PDCP header of a PDCP PDU that carries the DL packet, or by additionally sending a (PDCP) Selective IOD control PDU, as previously described. At the operation 834, the UE 802 receives the PDCP PDU, retrieves the DL packet in it, determines that IOD is required for delivering the DL packet based on the associated marking in PDCP, and based thereon, delivers the DL packet to the upper layer in accordance with the IOD mechanism, as previously described. Similarly, at the operation 836, a second DL packet of QoS flow #2 arrives at the gNB 804. At the operation 838, the gNB 804 sends the second DL packet with OOD marking in PDCP to the UE 802. For examples, the OOD marking in PDCP may be indicated by setting the OOD bit to value 1 or setting the IOD bit to value 0 in the PDCP header of a second PDCP PDU that carries the second DL packet, or by additionally sending a (PDCP) Selective OOD control PDU, as previously described. At the operation 840, the UE 802 receives the second PDCP PDU, retrieves the second DL packet in it, determines that IOD is not required for delivering the second DL packet based on the associated marking in PDCP, and based thereon, delivers the second DL packet to the upper layer in accordance with the OOD mechanism, as previously described.

The UL data operations 816 include operations 842, 844, 846, 848, 850, and 852. At the operation 842, a UL packet of QoS flow #1 from the upper layer arrives at the UE 802. At the operation 844, the UE 802 sends the UL packet with IOD marking in PDCP to the gNB 804. For examples, the IOD marking in PDCP may be indicated by setting the IOD bit to value 1 or setting the OOD bit to value 0 in the PDCP header of a third PDCP PDU that carries the UL packet, or by additionally sending a (PDCP) Selective IOD control PDU, as previously described. At the operation 846, the gNB 804 receives the third PDCP PDU, retrieves the UL packet in it, determines that IOD is required for delivering the UL packet based on the associated marking in PDCP, and based thereon, delivers the packet to the upper layer in accordance with the IOD mechanism, as previously described. Similarly, at the operation 848, a second UL packet of QoS flow #2 from the upper layer arrives at the UE 802. At the operation 850, the UE 802 sends the second UL packet with OOD marking in PDCP to the gNB 804. For examples, the OOD marking in PDCP may be indicated by setting the OOD bit to value 1 or setting the IOD bit to value 0 in the PDCP header of a fourth PDCP PDU that carries the second UL packet, or by additionally sending a (PDCP) Selective OOD control PDU, as previously described. At the operation 852, the gNB 804 receives the fourth PDCP PDU, retrieves the second UL packet in it, determines that IOD is not required for delivering the second UL packet based on the associated marking in PDCP, and based thereon, delivers the packet to the upper layer in accordance with the OOD mechanism, as previously described.

The operations 814 and 816 demonstrate how the network elements handle both downlink and uplink data packets based on the configurations established during the configuration operations 812. The disclosed techniques ensure proper classification, marking, and delivery of packets with consideration for In-Order Delivery (IOD) and Out-of-Order Delivery (OOD) requirements, on a per-packet basis, as configured earlier. This approach allows for efficient handling of multiple QoS flows mapped to the same DRB while maintaining their distinct delivery requirements.

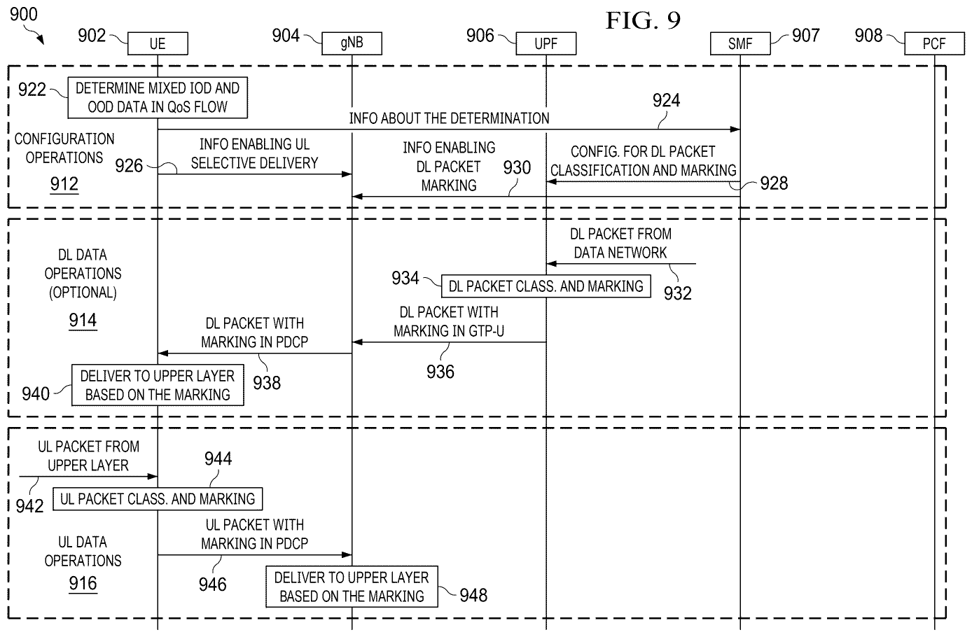

FIG. 9 illustrates a network flow 900, involving a UE 902, a gNB 904, a UPF 906, an SMF 907, and a PCF 908, according to some implementations. The operations of the network flow 900 may include three operation phases: configuration operations 912, DL data operations 914 (labeled as optional), and UL data operations 916.

The configuration operations 912 include operations 922, 924, 926, 928, and 930. At operation 922, higher layer(s) (e.g., Application and/or TCP layers) of the UE 902 determines that data of a QoS flow of the UE 902 include data requiring IOD and data not requiring IOD. At the operation 924, the UE 902 may inform the SMF 907 of the determination through NAS signaling. At the operation 928, the determination received by the SMF 907 may cause the SMF 907 to configure the UPF 906 to perform DPI on each DL packet on the QoS flow to determine whether IOD is required for the each DL packet or not (related to the operation 934), and based thereon, to send indication of IOD or OOD (i.e., marking in GTP-U) accordingly along with the each DL packet to the gNB 904 (related to the operation 936). At the operation 930, the SMF 907 may further indicate to the gNB 904, e.g., via QoS profile of QoS flow(s) that data of the QoS flow of the UE 902 include both data requiring IOD and data not requiring IOD, causing the gNB 904 to configure the use of selective OOD on the DRB, which is configured for carrying data of the QoS flow. Alternatively, at the operation 926, the UE 902 may inform the gNB 904 of the determination to cause the gNB 904 to configure the use of selective OOD on the DRB. In either case, the gNB 904 may configure the transmitting PDCP entity of the gNB 904 (as the DL transmitter) for the DRB to include indication of IOD or OOD in the PDCP header of the respective PDCP PDU carrying the each DL packet or to enable the use of (PDCP) Selective OOD control PDU or (PDCP) Selective IOD control PDU for conveying the indication of IOD or OOD (related to the operation 938). The gNB 904 may also configure the UE 902 (as the UL transmitter) to similarly determine, e.g., by the UE 902 inspecting specific field(s) in specific higher layer protocol header(s) of each UL packet on the QoS flow in accordance with the configuration, whether IOD is required for the each UL packet (related to the operation 944), and based thereon, to provide indication of IOD or OOD (i.e., marking in PDCP) to the gNB accordingly (related to the operation 946). The gNB 904 may also configure receiving PDCP entity of the UE 902 (as the DL receiver) for the DRB and receiving PDCP entity of the gNB 904 (as the UL receiver) for the DRB to perform selective OOD in accordance with the respective indication of IOD or OOD received (related to the operations 940 and 948, respectively).

The DL data operations 914 (optional) include operations 932, 934, 936, 938, and 940. At the operation 932, a DL packet arrives at the UPF 906 from a data network that is external to the 5G core network. At the operation 934, the UPF 906 performs DL packet classification (i.e., determination of whether IOD is required for the DL packet or not) and marking (i.e., inserting an indication of IOD or OOD accordingly). For example, the UPF 906 may perform DPI on the DL packet in accordance with the information provided with during the operation 928, such as the information about type(s) of higher layer packet or value(s) in specific field(s) in specific higher layer protocol header(s), etc. At the operation 936, the UPF 906 sends the DL packet with the associated marking in a GTP-U packet to the gNB 904. At the operation 938, the gNB 904 retrieves the DL packet and the marking from the GTP-U packet, then sends the DL packet in a PDCP PDU, along with an indication indicating IOD or OOD (i.e., marking in PDCP) that is consistent with the marking in GTP-U received from the UPF 906, to the UE 902. The marking in PDCP may be sent by using the OOD bit or the IOD bit in the PDCP header of the PDCP PDU, or by additionally sending a (PDCP) Selective OOD control PDU or (PDCP) Selective IOD control PDU, as previously described. At the operation 940, the UE 902 processes the PDCP PDU received to retrieve the DL packet, determines whether IOD is required for delivering the DL packet to the upper layer based on the IOD or OOD indication indicated in the PDCP header of the PDCP PDU, or in the (PDCP) Selective OOD control PDU, or in the (PDCP) Selective IOD control PDU, and delivers the packet to the upper layer in accordance with the corresponding delivery mechanism determined, as previously describe.

The UL data operations 916 include operations 942, 944, 946, and 948. At the operation 942, a UL packet from the upper layer arrives at the UE 902. At the operation 944, the UE 902 performs UL packet classification (i.e., determination of whether IOD is required for the UL packet or not) and marking (i.e., inserting an indication of IOD or OOD accordingly). At the operation 946, the UE 902 sends the UL packet in a second PDCP PDU, along with the associated marking in PDCP, to the gNB 904. The marking in PDCP may be sent by using the OOD bit or the IOD bit in the PDCP header of the second PDCP PDU or by additionally sending a (PDCP) Selective OOD control PDU or (PDCP) Selective IOD control PDU, as previously described. At the operation 948, the gNB 904 processes the second PDCP PDU received to retrieve the UL packet, determines whether IOD is required for delivering the UL packet to the upper layer based on the IOD or OOD indication indicated in the PDCP header of the second PDCP PDU, or in the (PDCP) Selective OOD control PDU, or in the (PDCP) Selective IOD control PDU, and based thereon, delivers the packet to the upper layer in accordance with the delivery mechanism determined, as previously described.

These operations demonstrate how the network elements handle both downlink and uplink data packets based on the configurations established during the configuration operations 912. The process ensures proper classification, marking, and delivery of packets with consideration for In-Order Delivery (IOD) and Out-of-Order Delivery (OOD) requirements, on a per-packet basis, as determined by the UE's higher layers.

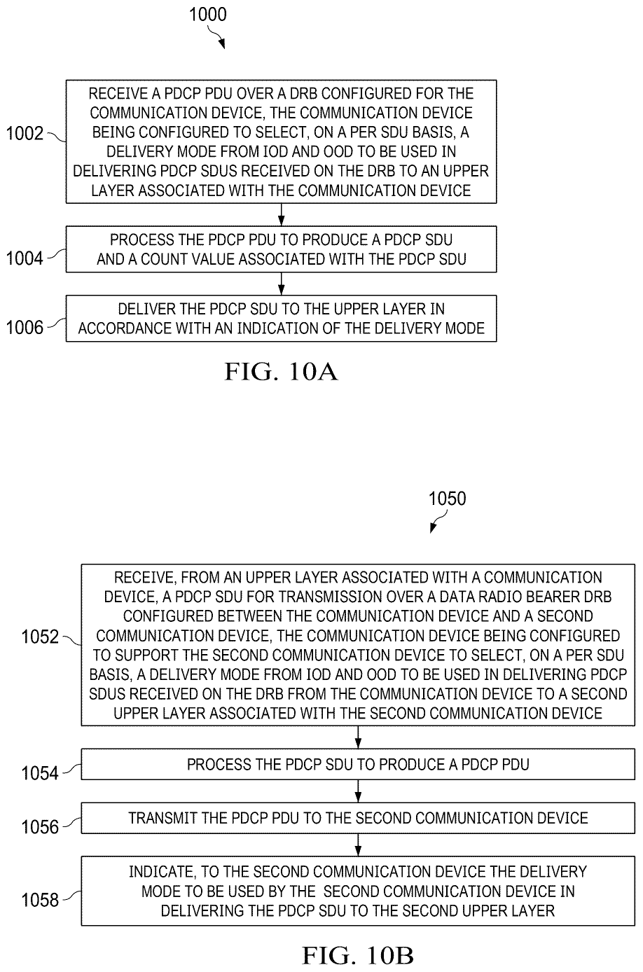

FIG. 10A shows a flow chart of a method 1000 performed by a communication device, according to some implementations. The communication device may include computer-readable code or instructions executing on one or more processors of the communication device. Coding of the software for carrying out or performing the method 1000 is well within the scope of a person of ordinary skill in the art having regard to the present disclosure. The method 1000 may include additional or fewer operations than those shown and described and may be carried out or performed in a different order. Computer-readable code or instructions of the software executable by the one or more processors may be stored on a non-transitory computer-readable medium, such as for example, the memory of the communication device. In some implementations, the method 1000 may be performed by one or more of units or modules (e.g., an integrated circuit) of the communication device, such as field programmable gate arrays (FPGAs) or application-specific integrated circuits (ASICs).

The method 1000 starts at the operation 1002, where the communication device receives a packet data convergence protocol (PDCP) protocol data unit (PDU) over a data radio bearer (DRB) configured for the communication device. The communication device is configured to select, on a per service data unit (SDU) basis, a delivery mode from in-order delivery (IOD) and out-of-order delivery (OOD) to be used in delivering PDCP SDUs received on the DRB to an upper layer associated with the communication device. At the operation 1004, the communication device processes the PDCP PDU to produce a PDCP SDU and a COUNT value associated with the PDCP SDU. At the operation 1006, the communication device delivers the PDCP SDU to the upper layer in accordance with an indication of the delivery mode.

In some implementations, a PDCP-config information element (IE) configured for the communication device may include first information indicating that performing the OOD selectively is configured for the DRB.

In some implementations, the communication device may deliver the PDCP SDU as soon as the PDCP SDU is produced from the processing the PDCP PDU.

In some implementations, the indication indicating the OOD may be included in a PDCP header of the PDCP PDU. The PDCP header may include a field for OOD bit which can be set to 1 to indicate the OOD, or the PDCP header may include a field for IOD bit which can be set to 0 to indicate the OOD. The details can refer to the above-mentioned embodiments.

In some implementations, the communication device may receive a first PDCP control PDU over the DRB. A PDU type field in the first PDCP control PDU may indicate the OOD. The COUNT value associated with the PDCP SDU may be indicated in the first PDCP control PDU as being associated with the OOD.

In some implementations, the COUNT value associated with the PDCP SDU being indicated in the first PDCP control PDU as being associated with the OOD may comprise the COUNT value associated with the PDCP SDU being indicated in a first OOD COUNT field in the first PDCP control PDU.

In some implementations, the COUNT value associated with the PDCP SDU being indicated in the first PDCP control PDU as being associated with the OOD may comprise a bit in a bitmap field in the first PDCP control PDU being set to a value indicating the OOD. A bit position of the bit in the bitmap field may correspond to the COUNT value associated with the PDCP SDU.

In some implementations, in response to the indication indicating the IOD, the communication device may deliver the PDCP SDU to the upper layer as if the OOD is not configured for the DRB.

In some implementations, the communication device may store the PDCP SDU in a buffer in response to determining that another PDCP SDU with a respective COUNT value less than the COUNT value associated with the PDCP SDU has not been received yet and is still waited for. The communication device may deliver the PDCP SDU to the upper layer in response to determining that all PDCP SDUs with the respective COUNT value less than the COUNT value associated with the PDCP SDU have either been delivered to the upper layer or been determined as being lost.

In some implementations, the indication indicating the IOD may be included in a PDCP header of the PDCP PDU. For example, the PDCP header may include a field for OOD bit which is set to 0 to indicate the IOD, or the PDCP header may include a field for IOD bit which is set to 1 to indicate the IOD. The details can refer to the above-mentioned embodiments.

In some implementations, the communication device may receive a second PDCP control PDU over the DRB. A PDU type field in the second PDCP control PDU may indicate the IOD. The COUNT value associated with the PDCP SDU may be indicated in the second PDCP control PDU as being associated with the IOD.

In some implementations, the communication device may be a UE or a (NB)

FIG. 10B shows a flow chart of a method 1050 performed by a communication device, according to some implementations. The communication device may include computer-readable code or instructions executing on one or more processors of the communication device. Coding of the software for carrying out or performing the method 1050 is well within the scope of a person of ordinary skill in the art having regard to the present disclosure. The method 1050 may include additional or fewer operations than those shown and described and may be carried out or performed in a different order. Computer-readable code or instructions of the software executable by the one or more processors may be stored on a non-transitory computer-readable medium, such as for example, the memory of the communication device. In some implementations, the method 1050 may be performed by one or more of units or modules (e.g., an integrated circuit) of the communication device, such as field programmable gate arrays (FPGAs) or application-specific integrated circuits (ASICs).

The method 1050 starts at the operation 1052, where the communication device receives, from an upper layer associated with the communication device, a packet data convergence protocol (PDCP) service data unit (SDU) for transmission over a data radio bearer (DRB) configured between the communication device and a second communication device. The communication device may be configured to support the second communication device to select, on a per SDU basis, a delivery mode from in-order delivery (IOD) and out-of-order delivery (OOD) to be used in delivering PDCP SDUs received on the DRB from the communication device to a second upper layer associated with the second communication device. At the operation 1054, the communication device processes the PDCP SDU to produce a PDCP protocol data unit (PDU). At the operation 1056, the communication device transmits the PDCP PDU to the second communication device. At the operation 1058, the communication device indicates, to the second communication device, the delivery mode to be used by the second communication device in delivering the PDCP SDU to the second upper layer.

In some implementations, a PDCP-config information element (IE) configured for the communication device may include first information indicating that supporting the second communication device to select the delivery mode is configured for the communication device.

In some implementations, in response to determining that the PDCP SDU does not require the IOD, the communication device may convey a first indication indicating the OOD to the second communication device.

In some implementations, the first indication indicating the OOD may be included in a PDCP header of the PDCP PDU transmitted to the second communication device. For example, the PDCP header may include a field for OOD bit which is set to 1 to indicate the OOD, or the PDCP header may include a field for IOD bit which is set to 0 to indicate the OOD. The details can refer to the above-mentioned embodiments.

In some implementations, the communication device may transmit a first PDCP control PDU over the DRB to the second communication device. A PDU type field in the first PDCP control PDU may indicate the OOD. A COUNT value associated with the PDCP SDU may be indicated in the first PDCP control PDU as being associated with the OOD. The first indication may comprise the first PDCP control PDU.

In some implementations, the COUNT value associated with the PDCP SDU being indicated in the first PDCP control PDU as being associated with the OOD may comprise the COUNT value associated with the PDCP SDU being indicated in a first OOD COUNT field in the first PDCP control PDU.

In some implementations, the COUNT value associated with the PDCP SDU being indicated in the first PDCP control PDU as being associated with the OOD may comprise a bit in a bitmap field in the first PDCP control PDU being set to a value indicating the OOD. A bit position of the bit in the bitmap field may correspond to the COUNT value associated with the PDCP SDU.

In some implementations, the communication device may receive a second indication indicating that the PDCP SDU does not require the IOD. In some implementations, the communication device may receive the PDCP SDU from the associated upper layer for the transmission over a first quality of service (QoS) flow. Data of the first QoS flow may not require the IOD.

In some implementations, in response to determining that the PDCP SDU requires the IOD, the communication device may convey a third indication indicating the IOD to the second communication device.

In some implementations, the third indication indicating the IOD may comprise an OOD bit set to 0 in a PDCP header of the PDCP PDU transmitted to the second communication device. In some implementations, the third indication indicating the IOD may comprise an IOD bit set to 1 in the PDCP header of the PDCP PDU transmitted to the second communication device.

In some implementations, the communication device may transmit a second PDCP control PDU over the DRB to the second communication device. A PDU type field in the second PDCP control PDU may indicate the IOD. A COUNT value associated with the PDCP SDU may be indicated in the second PDCP control PDU as being associated with the IOD.

In some implementations, the communication device may receive a fourth indication indicating that the PDCP SDU requires the IOD. In some implementations, the communication device may receive the PDCP SDU from the associated upper layer for the transmission over a second QoS flow. Data of the second QoS flow may require the IOD.

In some implementations, the communication device may be a UE or a gNB).

According to disclosed implementations, a UE (for UL packets) or a network node serving the UE (for DL packets) determines whether IOD being required or not for each packet of a DRB of the UE, and based thereon, conveys indication of whether IOD being required or not for the each packet to a transmitter on the DRB. The transmitter conveys the indication of whether IOD being required or not for the each packet to a receiver on the DRB. The receiver optimizes the delivery of each packet received on the DRB based on the indication of whether IOD being required or not for the each packet received.

The disclosed techniques allow a receiving PDCP entity at the receiver to deliver PDCP SDUs received and carrying a TCP ACK to the upper layer without waiting for any PDCP SDUs carrying a TCP data packet sent in the same direction, hence reducing the RTT, and meanwhile allowing the receiving PDCP entity to deliver PDCP SDUs received and carrying a TCP data packet in a same order in which the PDCP SDUs are transmitting at the transmitter.

The disclosed techniques reduce the RTT, which can avoid unnecessary data rate and throughput reduction due to a higher layer congestion control mechanism at the sender of the higher layer data.

The disclosed techniques delivering TCP data packets in-order can avoid unnecessary retransmissions at the higher layer.

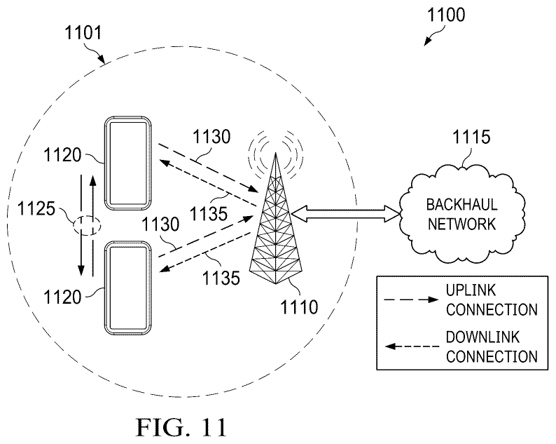

FIG. 11 illustrates an example communications system 1100. Communications system 1100 includes an access node 1110 serving user equipments (UEs) with coverage 1101, such as UEs 1120. In a first operating mode, communications to and from a UE passes through access node 1110 with a coverage area 1101. The access node 1110 is connected to a backhaul network 1115 for connecting to the internet, operations and management, and so forth. In a second operating mode, communications to and from a UE do not pass through access node 1110, however, access node 1110 typically allocates resources used by the UE to communicate when specific conditions are met. Communications between a pair of UEs 1120 can use a sidelink connection (shown as two separate one-way connections 1125). In FIG. 11, the sidelink communication is occurring between two UEs operating inside of coverage area 1101. However, sidelink communications, in general, can occur when UEs 1120 are both outside coverage area 1101, both inside coverage area 1101, or one inside and the other outside coverage area 1101. Communication between a UE and access node pair occur over uni-directional communication links, where the communication links between the UE and the access node are referred to as uplinks 1130, and the communication links between the access node and UE is referred to as downlinks 1135.

Access nodes may also be commonly referred to as Node Bs, evolved Node Bs (eNBs), next generation (NG) Node Bs (gNBs), master eNBs (MeNBs), secondary eNBs (SeNBs), master gNBs (MgNBs), secondary gNBs (SgNBs), network controllers, control nodes, base stations, access points, transmission points (TPs), transmission-reception points (TRPs), cells, carriers, macro cells, femtocells, pico cells, and so on, while UEs may also be commonly referred to as mobile stations, mobiles, terminals, users, subscribers, stations, and the like. Access nodes may provide wireless access in accordance with one or more wireless communication protocols, e.g., the Third Generation Partnership Project (3GPP) long term evolution (LTE), LTE advanced (LTE-A), 5G, 5G LTE, 5G NR, sixth generation (6G), High Speed Packet Access (HSPA), the IEEE 802.11 family of standards, such as 802.11a/b/g/n/ac/ad/ax/ay/be, etc. While it is understood that communications systems may employ multiple access nodes capable of communicating with a number of UEs, only one access node and two UEs are illustrated for simplicity.

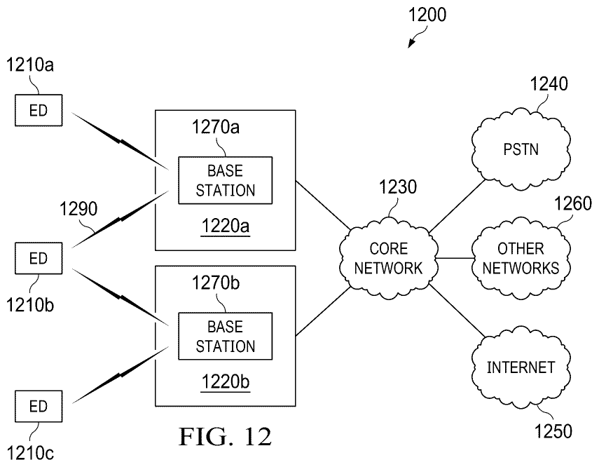

FIG. 12 illustrates an example communication system 1200. In general, the system 1200 enables multiple wireless or wired users to transmit and receive data and other content. The system 1200 may implement one or more channel access methods, such as code division multiple access (CDMA), time division multiple access (TDMA), frequency division multiple access (FDMA), orthogonal FDMA (OFDMA), single-carrier FDMA (SC-FDMA), or non-orthogonal multiple access (NOMA).

In this example, the communication system 1200 includes electronic devices (ED) 1210a-1210c, radio access networks (RANs) 1220a-1220b, a core network 1230, a public switched telephone network (PSTN) 1240, the Internet 1250, and other networks 1260. While certain numbers of these components or elements are shown in FIG. 12, any number of these components or elements may be included in the system 1200.

The EDs 1210a-1210c are configured to operate or communicate in the system 1200. For example, the EDs 1210a-1210c are configured to transmit or receive via wireless or wired communication channels. Each ED 1210a-1210c represents any suitable end user device and may include such devices (or may be referred to) as a user equipment or device (UE), wireless transmit or receive unit (WTRU), mobile station, fixed or mobile subscriber unit, cellular telephone, personal digital assistant (PDA), smartphone, laptop, computer, touchpad, wireless sensor, or consumer electronics device.

The RANs 1220a-1220b here include base stations 1270a-1270b, respectively. Each base station 1270a-1270b is configured to wirelessly interface with one or more of the EDs 1210a-1210c to enable access to the core network 1230, the PSTN 1240, the Internet 1250, or the other networks 1260. For example, the base stations 1270a-1270b may include (or be) one or more of several well-known devices, such as a base transceiver station (BTS), a Node-B (NodeB), an evolved NodeB (eNB), a Next Generation (NG) NodeB (gNB), a gNB centralized unit (gNB-CU), a gNB distributed unit (gNB-DU), a Home NodeB, a Home eNodeB, a site controller, an access point (AP), or a wireless router. The EDs 1210a-1210c are configured to interface and communicate with the Internet 1250 and may access the core network 1230, the PSTN 1240, or the other networks 1260.

In the embodiment shown in FIG. 12, the base station 1270a forms part of the RAN 1220a, which may include other base stations, elements, or devices. Also, the base station 1270b forms part of the RAN 1220b, which may include other base stations, elements, or devices. Each base station 1270a-1270b operates to transmit or receive wireless signals within a particular geographic region or area, sometimes referred to as a “cell.” In some embodiments, multiple-input multiple-output (MIMO) technology may be employed having multiple transceivers for each cell.

The base stations 1270a-1270b communicate with one or more of the EDs 1210a-1210c over one or more air interfaces 1290 using wireless communication links. The air interfaces 1290 may utilize any suitable radio access technology.

It is contemplated that the system 1200 may use multiple channel access functionality, including such schemes as described above. In particular embodiments, the base stations and EDs implement 5G New Radio (NR), LTE, LTE-A, or LTE-B. Of course, other multiple access schemes and wireless protocols may be utilized.

The RANs 1220a-1220b are in communication with the core network 1230 to provide the EDs 1210a-1210c with voice, data, application, Voice over Internet Protocol (VOIP), or other services. Understandably, the RANs 1220a-1220b or the core network 1230 may be in direct or indirect communication with one or more other RANs (not shown). The core network 1230 may also serve as a gateway access for other networks (such as the PSTN 1240, the Internet 1250, and the other networks 1260). In addition, some or all of the EDs 1210a-1210c may include functionality for communicating with different wireless networks over different wireless links using different wireless technologies or protocols. Instead of wireless communication (or in addition thereto), the EDs may communicate via wired communication channels to a service provider or switch (not shown), and to the Internet 1250.

Although FIG. 12 illustrates one example of a communication system, various changes may be made to FIG. 12. For example, the communication system 1200 could include any number of EDs, base stations, networks, or other components in any suitable configuration.

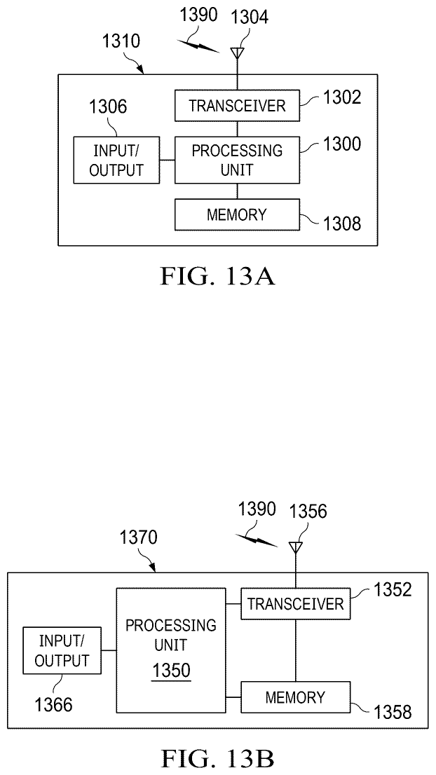

FIGS. 13A and 13B illustrate example devices that may implement the methods and teachings according to this disclosure. In particular, FIG. 13A illustrates an example ED 1310, and FIG. 13B illustrates an example base station 1370. These components could be used in the system 1200 or in any other suitable system.

As shown in FIG. 13A, the ED 1310 includes at least one processing unit 1300. The processing unit 1300 implements various processing operations of the ED 1310. For example, the processing unit 1300 could perform signal coding, data processing, power control, input/output processing, or any other functionality enabling the ED 1310 to operate in the system 1200. The processing unit 1300 also supports the methods and teachings described in more detail above. Each processing unit 1300 includes any suitable processing or computing device configured to perform one or more operations. Each processing unit 1300 could, for example, include a microprocessor, microcontroller, digital signal processor, field programmable gate array, or application specific integrated circuit.

The ED 1310 also includes at least one transceiver 1302. The transceiver 1302 is configured to modulate data or other content for transmission by at least one antenna or NIC (Network Interface Controller) 1304. The transceiver 1302 is also configured to demodulate data or other content received by the at least one antenna 1304. Each transceiver 1302 includes any suitable structure for generating signals for wireless or wired transmission or processing signals received wirelessly or by wire. Each antenna 1304 includes any suitable structure for transmitting or receiving wireless or wired signals. One or multiple transceivers 1302 could be used in the ED 1310, and one or multiple antennas 1304 could be used in the ED 1310. Although shown as a single functional unit, a transceiver 1302 could also be implemented using at least one transmitter and at least one separate receiver.

The ED 1310 further includes one or more input/output devices 1306 or interfaces (such as a wired interface to the Internet 1250). The input/output devices 1306 facilitate interaction with a user or other devices (network communications) in the network. Each input/output device 1306 includes any suitable structure for providing information to or receiving information from a user, such as a speaker, microphone, keypad, keyboard, display, or touch screen, including network interface communications.

In addition, the ED 1310 includes at least one memory 1308. The memory 1308 stores instructions and data used, generated, or collected by the ED 1310. For example, the memory 1308 could store software or firmware instructions executed by the processing unit(s) 1300 and data used to reduce or eliminate interference in incoming signals. Each memory 1308 includes any suitable volatile or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, and the like.

As shown in FIG. 13B, the base station 1370 includes at least one processing unit 1350, at least one transceiver 1352, which includes functionality for a transmitter and a receiver, one or more antennas 1356, at least one memory 1358, and one or more input/output devices or interfaces 1366. A scheduler, which would be understood by one skilled in the art, is coupled to the processing unit 1350. The scheduler could be included within or operated separately from the base station 1370. The processing unit 1350 implements various processing operations of the base station 1370, such as signal coding, data processing, power control, input/output processing, or any other functionality. The processing unit 1350 can also support the methods and teachings described in more detail above. Each processing unit 1350 includes any suitable processing or computing device configured to perform one or more operations. Each processing unit 1350 could, for example, include a microprocessor, microcontroller, digital signal processor, field programmable gate array, or application specific integrated circuit.

Each transceiver 1352 includes any suitable structure for generating signals for wireless or wired transmission to one or more EDs or other devices. Each transceiver 1352 further includes any suitable structure for processing signals received wirelessly or by wire from one or more EDs or other devices. Although shown combined as a transceiver 1352, a transmitter and a receiver could be separate components. Each antenna 1356 includes any suitable structure for transmitting or receiving wireless or wired signals. While a common antenna 1356 is shown here as being coupled to the transceiver 1352, one or more antennas 1356 could be coupled to the transceiver(s) 1352, allowing separate antennas 1356 to be coupled to the transmitter and the receiver if equipped as separate components. Each memory 1358 includes any suitable volatile or non-volatile storage and retrieval device(s). Each input/output device 1366 facilitates interaction with a user or other devices (network communications) in the network. Each input/output device 1366 includes any suitable structure for providing information to or receiving/providing information from a user, including network interface communications.

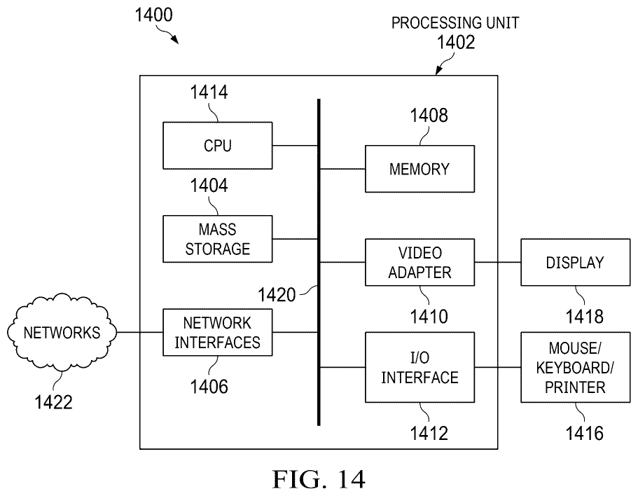

FIG. 14 is a block diagram of a computing system 1400 that may be used for implementing the devices and methods disclosed herein. For example, the computing system can be any entity of UE, access network (AN), mobility management (MM), session management (SM), user plane gateway (UPGW), or access stratum (AS). Specific devices may utilize all of the components shown or only a subset of the components, and levels of integration may vary from device to device. Furthermore, a device may contain multiple instances of a component, such as multiple processing units, processors, memories, transmitters, receivers, etc. The computing system 1400 includes a processing unit 1402. The processing unit includes a central processing unit (CPU) 1414, memory 1408, and may further include a mass storage device 1404, a video adapter 1410, and an I/O interface 1412 connected to a bus 1420.

The bus 1420 may be one or more of any type of several bus architectures including a memory bus or memory controller, a peripheral bus, or a video bus. The CPU 1414 may comprise any type of electronic data processor. The memory 1408 may comprise any type of non-transitory system memory such as static random access memory (SRAM), dynamic random access memory (DRAM), synchronous DRAM (SDRAM), read-only memory (ROM), or a combination thereof. In an embodiment, the memory 1408 may include ROM for use at boot-up, and DRAM for program and data storage for use while executing programs.

The mass storage 1404 may comprise any type of non-transitory storage device configured to store data, programs, and other information and to make the data, programs, and other information accessible via the bus 1420. The mass storage 1404 may comprise, for example, one or more of a solid state drive, hard disk drive, a magnetic disk drive, or an optical disk drive.

The video adapter 1410 and the I/O interface 1412 provide interfaces to couple external input and output devices to the processing unit 1402. As illustrated, examples of input and output devices include a display 1418 coupled to the video adapter 1410 and a mouse, keyboard, or printer 1416 coupled to the I/O interface 1412. Other devices may be coupled to the processing unit 1402, and additional or fewer interface cards may be utilized. For example, a serial interface such as Universal Serial Bus (USB) (not shown) may be used to provide an interface for an external device.

The processing unit 1402 also includes one or more network interfaces 1406, which may comprise wired links, such as an Ethernet cable, or wireless links to access nodes or different networks. The network interfaces 1406 allow the processing unit 1402 to communicate with remote units via the networks. For example, the network interfaces 1406 may provide wireless communication via one or more transmitters/transmit antennas and one or more receivers/receive antennas. In an embodiment, the processing unit 1402 is coupled to a local-area network 1422 or a wide-area network for data processing and communications with remote devices, such as other processing units, the Internet, or remote storage facilities.

It should be appreciated that one or more steps of the embodiment methods provided herein may be performed by corresponding units or modules. For example, a signal may be transmitted by a transmitting unit or a transmitting module. A signal may be received by a receiving unit or a receiving module. A signal may be processed by a processing unit or a processing module. Other steps may be performed by a performing unit or module, a generating unit or module, an obtaining unit or module, a setting unit or module, an adjusting unit or module, an increasing unit or module, a decreasing unit or module, a determining unit or module, a modifying unit or module, a reducing unit or module, a removing unit or module, or a selecting unit or module. The respective units or modules may be hardware, software, or a combination thereof. For instance, one or more of the units or modules may be an integrated circuit, such as field programmable gate arrays (FPGAs) or application-specific integrated circuits (ASICs).

Although the description has been described in detail, it should be understood that various changes, substitutions and alterations can be made without departing from the spirit and scope of this disclosure as defined by the appended claims. Moreover, the scope of the disclosure is not intended to be limited to the particular embodiments described herein, as one of ordinary skill in the art will readily appreciate from this disclosure that processes, machines, manufacture, compositions of matter, means, methods, or steps, presently existing or later to be developed, may perform substantially the same function or achieve substantially the same result as the corresponding embodiments described herein. Accordingly, the appended claims are intended to include within their scope such processes, machines, manufacture, compositions of matter, means, methods, or steps.

1. A method, comprising:
receiving, by a communication device, a packet data convergence protocol (PDCP) protocol data unit (PDU) over a data radio bearer (DRB) configured for the communication device, wherein the PDCP PDU comprises an indication of a delivery mode that is to be used in delivering a PDCP SDU received in the PDCP PDU to an upper layer associated with the communication device, and the indication of the delivery mode indicates in-order delivery (IOD) or out-of-order delivery (OOD);
processing, by the communication device, the PDCP PDU to produce the PDCP SDU and a COUNT value associated with the PDCP SDU; and
delivering, by the communication device, the PDCP SDU to the upper layer in accordance with the indication of the delivery mode.

2. The method of claim 1, wherein the communication device is configured with a PDCP-config information element (IE) including first information indicating that performing the OOD is configured for the DRB.

3. The method of claim 1, the delivering comprising:
in response to the indication indicating the OOD, delivering, by the communication device, the PDCP SDU to the upper layer as if the OOD is configured for the DRB.

4. The method of claim 3, the delivering the PDCP SDU to the upper layer as if the OOD is configured for the DRB comprising delivering the PDCP SDU regardless of another PDCP SDU with a respective COUNT value less than the COUNT value associated with the PDCP SDU has been received.

5. The method of claim 1, wherein a PDCP header of the PDCP PDU includes at least one of an OOD bit or an IOD bit to indicate the indication of the delivery mode.

6. The method of claim 1, further comprising:
receiving, by the communication device, a first PDCP control PDU over the DRB, the first PDCP control PDU including a PDU type field indicating the OOD, the COUNT value associated with the PDCP SDU being indicated in the first PDCP control PDU as being associated with the OOD, the indication indicating the OOD comprises the first PDCP control PDU.

7. The method of claim 6, wherein the COUNT value associated with the PDCP SDU being indicated in the first PDCP control PDU as being associated with the OOD comprises:
the COUNT value associated with the PDCP SDU being indicated in a first OOD COUNT field in the first PDCP control PDU, or
a bit in a bitmap field in the first PDCP control PDU being set to a value indicating the OOD, a bit position of the bit in the bitmap field corresponding to the COUNT value associated with the PDCP SDU.

8. The method of claim 1, the delivering comprising:
in response that the indication indicating the delivery mode indicates the IOD, delivering, by the communication device, the PDCP SDU to the upper layer as if the OOD is not configured for the DRB.

9. The method of claim 8, the delivering the PDCP SDU to the upper layer as if the OOD is not configured for the DRB comprising:
storing the PDCP SDU in a buffer in response to determining that another PDCP SDU with a respective COUNT value less than the COUNT value associated with the PDCP SDU has not been received yet and is still waited for; and
delivering the PDCP SDU to the upper layer in response to determining that all PDCP SDUs with the respective COUNT value less than the COUNT value associated with the PDCP SDU have either been delivered to the upper layer or been determined as being lost.

10. The method of claim 1, further comprising:
receiving, by the communication device, a second PDCP control PDU over the DRB, the second PDCP control PDU including a PDU type field indicating the IOD, the COUNT value associated with the PDCP SDU being indicated in the second PDCP control PDU as being associated with the IOD, the indication indicating the IOD comprising the second PDCP control PDU.

11. The method of claim 1, the communication device being a user equipment (UE) or a base station.

12. A method, comprising:
receiving, by a communication device from a first upper layer associated with the communication device, a packet data convergence protocol (PDCP) service data unit (SDU) for transmission over a data radio bearer (DRB) configured between the communication device and a second communication device;
processing, by the communication device, the PDCP SDU to produce a PDCP protocol data unit (PDU) that comprises an indication of a delivery mode, the indication of the delivery mode indicating in-order delivery (IOD) or out-of-order delivery (OOD), the delivery mode being used for delivering the PDCP SDU received on the DRB from the communication device to a second upper layer associated with the second communication device; and
transmitting, by the communication device, the PDCP PDU to the second communication device.

13. The method of claim 12, wherein the communication device is configured with a PDCP-config information element (IE) including first information indicating that performing the OOD is configured for the DRB.

14. The method of claim 12, wherein a PDCP header of the PDCP PDU includes at least one of an OOD bit or an IOD bit to indicate the indication of the delivery mode.

15. The method of claim 12, further comprising:
transmitting, by the communication device, a first PDCP control PDU over the DRB to the second communication device, the first PDCP control PDU including a PDU type field indicating the OOD, a COUNT value associated with the PDCP SDU being indicated in the first PDCP control PDU as being associated with the OOD, the indication comprising the first PDCP control PDU.

16. The method of claim 15, wherein the COUNT value associated with the PDCP SDU being indicated in the first PDCP control PDU as being associated with the OOD comprises:
the COUNT value associated with the PDCP SDU being indicated in a first OOD COUNT field in the first PDCP control PDU, or
a bit in a bitmap field in the first PDCP control PDU being set to a value indicating the OOD, a bit position of the bit in the bitmap field corresponding to the COUNT value associated with the PDCP SDU.

17. The method of claim 12, the method further comprising:
transmitting, by the communication device, a second PDCP control PDU over the DRB to the second communication device, the second PDCP control PDU including a PDU type field indicating the IOD, a COUNT value associated with the PDCP SDU being indicated in the second PDCP control PDU as being associated with the IOD.

18. The method of claim 12, the communication device being a user equipment (UE) or a base station.

19. A communication device, comprising:
at least one processor; and
a non-transitory computer readable storage medium storing programming instructions that, when executed by the at least one processor, cause the communication device to perform operations including:
receiving a packet data convergence protocol (PDCP) protocol data unit (PDU) over a data radio bearer (DRB) configured for the communication device, wherein the PDCP PDU comprises an indication of a delivery mode that is to be used in delivering a PDCP SDU received in the PDCP PDU to an upper layer associated with the communication device, and the indication of the delivery mode indicates in-order delivery (IOD) or out-of-order delivery (OOD);
processing the PDCP PDU to produce the PDCP SDU and a COUNT value associated with the PDCP SDU; and
delivering the PDCP SDU to the upper layer in accordance with the indication of the delivery mode.

20. A communication device, comprising:
at least one processor; and
a non-transitory computer readable storage medium storing programming instructions that, when executed by the at least one processor, cause the communication device to perform operations including:
receiving, from a first upper layer associated with the communication device, a packet data convergence protocol (PDCP) service data unit (SDU) for transmission over a data radio bearer (DRB) configured between the communication device and a second communication device;
processing the PDCP SDU to produce a PDCP protocol data unit (PDU) that comprises an indication of a delivery mode, the indication of the delivery mode indicating in-order delivery (IOD) or out-of-order delivery (OOD), the delivery mode being used for delivering the PDCP SDU received on the DRB from the communication device to a second upper layer associated with the second communication device; and
transmitting the PDCP PDU to the second communication device.
